(19) United States
(12) Patent Application Publication
(10) Pub. No.: US 2014/0021903 A1
(43) Pub. Date: Jan. 23, 2014

(54) WINDOWS AND DOORS HAVING INTEGRATED SOLAR POWERED CHARGING DEVICES

(71) Applicant: VEKA INC., Fombell, PA (US)

(72) Inventor: KEVIN A. SEILING, Monaca, PA (US)

(73) Assignee: VEKA INC., Fombell, PA (US)

(21) Appl. No.: 13/718,112

(22) Filed: Dec. 18, 2012

Related U.S. Application Data
(63) Continuation-in-part of application No. 13/552,383, filed on Jul. 18, 2012.

(51) Int. Cl. H02J 7/00; E06B 7/28

(52) U.S. Cl. CPC H02J 7/0042; E06B 7/28
USPC 320/101; 52/173.3

(57) ABSTRACT

An integral energy collector and charging system is provided in windows, associated screens and doors so as to facilitate harvesting of solar energy through solar energy collectors. Unique distribution channels for employing such energy to charge storage batteries which, in turn, provide energy to power outlets. The power outlets may be accessed in order to charge various types of devices. The system is employable with a wide variety of window and door constructions. In other embodiments, systems are provided which are independent products not portions of window or door systems or necessarily part of the building structure. Some embodiments contemplate systems not involving windows or doors, but which are securable to exterior walls and floors, such as post caps, deck boxes, wedges and foot pegs.

### CROSS REFERENCE TO RELATED APPLICATION

The present application is a continuation-in-part of U.S. Ser. No. 13/552,383 filed Jul. 18, 2012 entitled “Windows and Doors Having Integrated Solar Powered Charging Devices”, the disclosure of which is expressly incorporated herein by reference.

### BACKGROUND OF THE INVENTION

1. Field of the Invention

The present invention relates to improved means for efficiently integrating solar powered charging devices into windows and doors and, more specifically, it relates to such systems which may be employed with a variety of windows and doors and may be used to energize a wide variety of devices.

2. Description of the Prior Art

It has been known to have solar collectors absorb the sun's rays and convert the sun's energy into electrical output for various uses.

United States Patent Application Publication No. US 2008/0125188 discloses a cellular phone case which includes a solar cell and associated circuit board and a battery board which is electrically connected to the circuit board. A socket for providing electrical input into the battery or obtaining output of electrical energy from the battery is disclosed.

United States Patent Application Publication No. US 2008/0200221 discloses a solar panel for charging a battery which is operatively associated with a mobile communications device.

United States Patent Application Publication No. US 2007/0278989 discloses a solar charged battery within a power supply which is structured to charge objects such as cell phones, personal digital assistance and portable personal computers.

U.S. Pat. No. 5,905,356 discloses a solar powered charger for vehicle accessories and cordless tools such as cellular phones.

U.S. Pat. No. 7,777,128 discloses a pair of mechanical or electrical photovoltaic cells each having an electrode for use in a wide variety environments, including windows, but provides no details regarding the specific end use applications.

U.S. Pat. No. 6,608,464 discloses solar cells which are laminated onto a rechargeable energy source such as a solid state polymer battery which in turn may be operatively associated with circuits which manage battery charging. See also, U.S. Pat. No. 7,781,672.

United States Patent Application Publication No. US 2011/0083719 discloses a dye-sensitized solar cell which functions both as a solar cell and a display unit. The solar cell unit is said to charge a storage battery which provides energy to a light source. Attaching the solar cell to a window is suggested. A mobile device such as a mobile phone handset is also disclosed.

United States Patent Application Publication No. US 2010/0294354 discloses a patterned photovoltaic device which has predetermined openings and may be mounted in a window of a building to provide a decorative function.

Chinese Patent CN20139201 discloses a solar window for a steamship. A solar battery board is provided on the glass surface of the window main body. The solar battery board converts the optical energy to power, which is stored in a storage battery, with the electrical output thereof serving to energize apparatus such as mobile phones.

Chinese Patent CN201714229 discloses a solar window which cooperates with solar battery panel on the illuminated side of a window frame with the battery panel being connected to a storage battery through a charging controller. The storage battery is also said to be connected to a USB charging socket.

United States Patent Application Publication No. US 2008/0236654 discloses a window which incorporates a thin-film photovoltaic system for converting solar energy into electrical energy. A controller is connected to the photovoltaic system and to the building power grid to energize devices used within the building.

French Patent No. FR2829633 discloses a solar screen contained within a housing which includes a liquid crystal screen able to display a charge indicating light emitting diode along with a cut-off switch. The housing has a charging cable fitted with a mobile phone charging connector.

United States Patent Application Publication No. US 2009/0058354 discloses a solar-powered media system which includes a docking station for holding an iPod.

United States Patent Application Publication No. US 2004/0204179 disclosed a multi-socket solar energy system for charging a battery which is capable of energizing a mobile phone.

United States Patent Application Publication No. US 2011/0023931 discloses a solar energy system which has adjustment means for altering the angle of the solar panel. It also discloses a battery 21 for storing electrical power and a USB socket.

United States Patent Application Publication No. US 2009/0173008 discloses the use of a photovoltaic charging driving device to move the slats of a shutter to various positions.

United States Patent Application Publication No. US 2011/0095719 discloses a photovoltaic array with a border surrounding the same and an outlet. The array is connected to a battery and transfers electrical energy thereto.

United States Patent Application Publication No. US 2011/0228520 discloses a skylight which has a solar panel array which is associated with a rechargeable power source and a plurality of lighting elements to illuminate the floor of a building.

United States Application Publication No. US 2011/0265694 discloses a solar powered umbrella table which energizes batteries. It also discloses the use of an inverter to convert DC voltage output from the batteries to 120 volts AC.

United States Patent Application Publication No. US 2011/0273133 discloses a solar USB charger which is said to provide energy without use of an internal battery for purposes of charging electronic devices such as iPods, and iPhone. Reference is made to optional rechargeable battery use.

U.S. Pat. No. 4,539,516 discloses a solar cell for recharging button batteries.

U.S. Pat. No. 4,717,790 discloses a laminated solar cell having an elastic thermosetting adhesive foil and a glass pane. It contemplates the device being curved to accommodate the shape of the window of an automobile, home or boat.

U.S. Pat. No. 4,830,038 discloses an encapsulated photovoltaic panel which has a plug for delivering electricity to an external device.

U.S. Pat. No. 5,221,363 discloses solar cells mounted in a window which has a pair of transparent glass panes between which a window blind is mounted. The solar cells are disposed on the slats of the window blind in order to obtain exposure to sunlight. Batteries are mounted on the slats and delivery of energy to a power bus is disclosed.

U.S. Pat. No. 5,741,369 discloses a plate-like structure with a solar battery for a sound insulation wall. This is designed to provide a source of electricity along a highway.

U.S. Pat. No. 6,063,996 discloses a solar cell module having a plurality of photovoltaic elements mounted on a roof to provide a source of electricity for possible use in connection with a heat collecting panel.

U.S. Pat. No. 6,326,764 discloses a solar system for energizing a CD player. The solar panel is adjustable with respect to the angle of the sun's rays. The energy absorbed is said to be usable either directly or in recharging a battery.

U.S. Pat. No. 6,617,822 discloses a system which has a solar collector, appropriate wiring and a storage battery. It is designed for use on a vehicle and cooperates with the vehicle battery.

U.S. Pat. No. 6,646,196 discloses a multi-paneled window having at least one of the panels provided with a plurality of solar panels. Wiring connects the photovoltaic panel with a battery which is to be recharged. DC and AC embodiments are disclosed.

U.S. Pat. No. 6,762,582 discloses a solar device which is said to permit powering of an electric-powered device such as a vehicle. See also, U.S. Pat. No. 6,856,116 which states that the electric power generated by each solar source is independently communicated to a battery.

U.S. Pat. No. 7,565,968 discloses a portable survival kit which employs a solar panel and a pair of rechargeable energy sources.

U.S. Pat. No. 8,018,098 discloses a portable solar power system wherein energy is delivered to a control block for storing the power. The use of a USB interface as well as a DC power output interface is disclosed. U.S. Pat. No. 8,129,938 discloses a system which employs a solar energy to supply power to a portable device.

U.S. Pat. No. 8,041,029 discloses a mount for an electronic device to be mounted on a vehicle dashboard. It contains a solar cell and a battery system which operates a navigation device.

U.S. Pat. No. 8,080,972 discloses a system for storing and releasing energy. A rechargeable battery unit is associated with a solar panel wherein the alternative AC adapter which is plugged into a wall outlet.

Korean Patent 20020012883 discloses a portable electronic solar cell system with an enlarged solar collector.

Chinese Patent Application 20072006228 discloses a portable solar electric source.

Japanese Patent 2010-104155 discloses a charger for a portable electronic apparatus such as a cellular phone, a digital camera or a portable game machine. A solar panel is said to charge a secondary battery with the charging unit said to provide an AC connector socket with a reference to a “USB connector socket.

Japanese Patent 58197781 discloses a window having optical battery panels arranged to effect rotation of slats to align the same with the source of solar light.

There remains a very real and substantial need for improved means of providing as an integral component of windows and doors an energy collecting, storing and delivery system usable on a wide variety of windows and doors and an energizing a number of different types of electricity consuming devices.

### SUMMARY OF THE INVENTION

The invention provides a window or door having an integral energy collector and charging system. It provides for one or more solar collectors to be positioned on the exterior of the window or door and a rechargeable battery operatively associated with a power outlet such as an USB port disposed on the interior of the window or door. Depending on the construction of the window or door, various designs for providing electrical conductors connected to the solar collector and to the battery to facilitate charging of the battery for delivery to the power outlet which may be a USB port.

The solar collector may have an upper portion secured to the window or door and extend angularly, downwardly and outwardly so as to facilitate efficient collection of solar energy. A protective bellows element may be provided to resist undesired entry of insects and foreign matter into the solar collector system. A protective cage may be positioned around the exterior of the solar collector to resist tampering of the same.

The solar collector may be secured to framing portions of the windows or doors, glass or other panel portions of the windows or doors with the electrical conductors passing through hollow framing members where the window or door construction is appropriate for that treatment.

The solar collector may be secured to a screen associated with a window or door.

The solar collector system of the present invention is suitable for both residential and commercial construction and may be manufactured as part of the original window or door construction or may be retrofit into existing structures.

Where a movable sash is involved, one or more solar collectors may be provided on the movable sash and one or more solar collectors may be provided on the frame therefor.

A number of additional refinements to the invention, some of which involve the embodiments in windows which have screens with some of these facilitating retrofit of the system. Additional modifications to windows such as a ventilator combination with the solar system or the use of an switchable glazing lite which is responsive to a battery which is energized by a solar collector will through a switch will cause the glazing to become opaque. This provides privacy and reduces solar heat through the glazing to near zero.

Additional embodiments involve the use of charging pads and various types of chargers. The invention also contemplates the use of weatherstripping to facilitate efficient retrofitting of a system with a wooden window.

Additional embodiments with self-contained systems which have solar collectors charging batteries and weatherproof power outlets are disclosed. Some of these are designed to serve as a multiple functioning product such as by supporting a rail or structurally fitting into an external floor or wall or post.

It is an object of the present invention to provide a window or door mounted solar system employable to charge a battery(s) which in turn may energize a product through the use of a “USB” port or other means.

It is a further object of this invention to provide such a system which may be employed in new construction, replacement windows and doors, and field application.

It is yet another object of the present invention to provide such a system which is usable on both residential and commercial windows and doors.

It is another object of the invention to provide such a system for windows and doors which serves to reduce the cost of wiring electrical outlets for a building, reduce fire hazards and increase the convenience of use.

It is yet another object of the present invention to provide such a system which may be employed on windows and doors made from wood, aluminum, steel, vinyl, fiberglass and composites.

It is yet another object of the present invention to provide such a system which is usable with movable and fixed pane windows as well as screens which are employable with the same.

It is yet another object of the present invention to provide such solar energy systems which are economical to install, durable and economical to use.

It is yet another object of the invention to provide a solar panel and screen which may readily be retrofit into existing windows.

It is another object of the invention to provide a solar box which may be secured within an opening of a deck such that the solar panels are exteriorly exposed as is a weatherproof power outlet.

It is a further object of the present invention to provide a solar box which may be secured in floors or walls such that they may present a flush surface with respect to the adjacent portion of such floors and walls.

It is another object of the present invention to provide a solar collector and screen which may be positioned exteriorly of a single hung window.

It is another object of the present invention to provide a window or door having an switchable glazing lite which can be energized to darken.

It is yet another object of the present invention to provide a window wall which has secured to the framing members thereof a solar collector which may contain more than one individual collector.

It is yet another object of the invention to provide a double hung window with a full screen and associated solar panel.

It is yet another object of the present invention to provide a window construction having at least one portable battery charger a charging pad and a battery charger, each operatively associated with a power outlet which may be a USB port.

It is yet another object of the present invention to provide a window or door construction which has a combination solar panel and ventilator.

It is another object of the invention to provide a multifunctional independent element which will serve to present a solar energized power outlet while providing an additional function such as being an outdoor structural support.

It is yet another object of the present invention to provide a post cap containing a solar energized power outlet which may be esthetically pleasing.

It is yet another object of the present invention to provide a solar collector secured to a housing which is structured to be secured to and supported by a structural member.

It is a further object of the present invention to provide solar collectors as part of a factory created structure or a retrofit in the end use environment with the solar collectors being angularly disposed for a maximum efficiency of the collection of solar energy to energize a battery which is operatively associated with a power outlet.

These and other objects of the invention will be more fully understood from the following description of the invention on reference to the illustrations appended hereto.

### BRIEF DESCRIPTION OF THE DRAWINGS

FIG. 1 is a front elevational view of a rotatable window of the present invention.

FIG. 2 is a cross-sectional view of the window of FIG. 1 taken through 2-2.

FIG. 3 is a cross-sectional illustration of the window of FIG. 1 taken through 3-3.

FIG. 4 is an elevational view of a form of storage battery and power outlet combination of the present invention.

FIG. 5 is a left-hand elevational view of FIG. 4 of the present invention shown without the cover in place.

FIG. 6 is an elevational view of the battery/preferred USB structure with the cover in place.

FIG. 7 is an alternate embodiment of the storage battery housing showing two end-to-end storage batteries with two USB access ports.

FIG. 8 is a front elevational view of a multi-pane window having a solar collector system installed within a window screen.

FIG. 9 is a cross-sectional view taken through 9-9 of FIG. 8 showing a portion of the solar collector device.

FIG. 10 is a detailed elevational view showing a portion of the solar collector and related screen.

FIG. 11 is a front elevational view of a storefront having a plurality of fixed panels and a plurality of solar collectors.

FIG. 12 is a fragmentary illustration in elevation partially in section showing a portion of the storefront collector layout of FIG. 11.

FIG. 13 is a cross-sectional illustration showing a portion of the storefront solar collector layout of FIG. 11 in vertical section.

FIG. 14 is a front elevational view from the exterior of a building showing a window having a fixed lite with two panes of glass and a lower movable sash with two panes of glass.

FIG. 15 shows a horizontal section taken through 15-15 of FIG. 14.

FIG. 16 is a vertical cross-sectional view taken through 16-16 of FIG. 14.

FIG. 17 is a front elevational view from the building interior of a swing door having two solar collector systems of the present invention.

FIG. 18 is a vertical cross-section of the rotating or swing-door of FIG. 17 designed for in-swing or rotation into the room.

FIG. 19 is a vertical section of a rotating or swinging door designed for out-swing or rotation to the outside.

FIG. 20 is a front elevational view of a window having two fixed lites and a solar collector secured therebetween.

FIG. 21 is a cross-sectional illustration taken through 21-21 of FIG. 20.

FIG. 22 is a front elevational view of a single hung window having a screen and solar collector operatively associated with the screen.

FIG. 23 is a cross-sectional view of the window-screen-solar collector assembly of FIG. 22 taken through 23-23.

FIG. 24 is a cross-sectional view of the window-screen-solar collector assembly of FIG. 22 taken through 24-24.

FIG. 25 is a cross-sectional view of the window-screen-solar collector assembly of FIG. 22 taken through 25-25.

FIG. 26 is elevational view partially exploded showing the solar collector components and screen.

FIG. 27 is a front elevational view of a base member to which the solar collector is secured.

FIG. 28 is a cross-sectional view through 28 of 28.

FIG. 29 is a front elevational view of the back up member of FIGS. 27 and 28.

FIG. 30 is a perspective view of a solar collector support for use in an adjustable angle system.

FIG. 31 is a front elevational view of the support of FIG. 30.

FIG. 32 is a top plan view of the support of FIG. 30.

FIG. 33 is a right side elevational view of the support of FIG. 30.

FIG. 34 is a perspective view of a first component of a two component bracket for use with the support of FIG. 30.

FIG. 35 is a front elevational view of the support component of FIG. 34.

FIG. 36 is a top plan view of the support component of FIG. 34.

FIG. 37 is a right side elevational view of the support component of FIG. 35.

FIG. 38 is a perspective view of the second frame component to be used with the frame component of FIG. 34 in supporting the solar collector support of FIG. 30.

FIG. 39 is a front elevational view of the support component of FIG. 38.

FIG. 40 is a top plan view of the support component of FIG. 39.

FIG. 41 is a right side elevational view of the support component of FIG. 39.

FIG. 42 is a front elevational view of the window having additional electrical options.

FIG. 43 is a left side elevational view of the window of FIG. 42.

FIG. 44 is an exploded view showing the component parts for establishing the solar collector as a rotatable solar collector.

FIG. 45 is a top view showing the assembled rotatable solar collector.

FIG. 46 is a perspective view showing the assembled solar collector.

FIG. 47 is a perspective view of a double sash window.

FIG. 48 is a perspective view showing an anchor for securing a solar collector assembly to a mullion.

FIG. 49 shows a perspective view of a solar collector support secured to the anchor of FIG. 48.

FIG. 50 shows a perspective view of the solar collector and support assembly.

FIG. 51 shows a turn and tilt window in the closed position.

FIG. 52 shows a cross-sectional illustration of the tilt and turn window of FIG. 51 taken through 52-52.

FIG. 53 shows the turn and tilt window of FIG. 51 with the window in a turned opened position.

FIG. 54 is a cross-sectional view taken through 54-54 of FIG. 53 showing the turned open position of the tilt and turn window.

FIG. 55 shows the window of FIG. 51 tilted open.

FIG. 56 is a cross-sectional view taken through 56-56 of FIG. 55 showing the tilted open position.

FIG. 57 is a vertical cross-sectional illustration of the tilt and turn window similar to FIG. 52, but showing the solar collector the associated wiring and the storage battery.

FIG. 58 is a horizontal cross-sectional view showing the window of FIG. 57 with the solar collector, wiring, associated battery and USB port.

FIG. 59 is a front elevational view of a window and screen combination of the present invention.

FIG. 60 is a cross-sectional illustration of the window and screen assembly of FIG. 59 taken through 60-60.

FIG. 61 is a cross-sectional illustration of the window and screen assembly of FIG. 59 taken through 61-61.

FIG. 62 is a cross sectional illustration of the window and screen assembly of FIG. 59 as taken through 62-62.

FIG. 63 is a front elevational view of a solar box which may be inserted into a floor such as a deck or a wall construction.

FIG. 64 is a right side elevation of the solar box of FIG. 63.

FIG. 65 is a left side elevation of the solar box of FIG. 63.

FIG. 66 is a bottom plan view of the solar box of FIG. 63.

FIG. 67 is a top plan view of the solar box of FIG. 63.

FIG. 68 is a rear elevational view of the solar box of FIG. 63.

FIG. 69 is a cross-sectional view of the solar box through 69-69 of FIG. 63.

FIG. 70 is a partial cross-sectional view of the soar box of FIGS. 63 through 69 shown within an opening in a wooden deck.

FIG. 71 is a front elevational view of a single hung window with a combination pivoting screen and solar collector.

FIG. 72 is a cross-sectional illustration of the single hung pivoting screen solar collector of FIG. 71 taken through 72-72.

FIG. 73 is a cross-sectional illustration of the single hung solar screen assembly of FIG. 71 taken through 73-73.

FIG. 74 is a cross-sectional view of the window of FIG. 71 similar to FIG. 73, showing the screen rotated farther out.

FIG. 75 is a front elevational view of a framed switchable glazing unit.

FIG. 76 is a cross-sectional illustration of the glass lite collector of FIG. 75 taken through 76-76.

FIG. 77 is a front elevational view of a window wall structure having a plurality of solar collectors.

FIG. 78 is a cross-sectional illustration of the window wall of FIG. 77 taken through 78-78.

FIG. 79 is a cross-sectional illustration of the window wall of FIG. 77 taken through 79-79

FIG. 80 is a front elevational view of a double hung full screen solar panel embodiment of the present invention.

FIG. 81 is a rear elevational view of the double hung assembly of the FIG. 80.

FIG. 82 is a cross-sectional illustration of the double hung assembly taken through 82-82 of FIG. 81.

FIG. 83 is a cross-sectional illustration taken through 83-83 of FIG. 81.

FIG. 84 is an elevational view of a window having a plurality of intermediate means for receiving electrical energy obtained from a solar collector and converting it to output at an electrical outlet.

FIG. 85 is a cross-sectional view taken through 85-85 of the window of FIG. 84.

FIG. 86 is a front elevational view of a window having a solar collector and a ventilator.

FIG. 87 is rear elevational view of the window of FIG. 86.

FIG. 88 is a cross-sectional view of the window of FIG. 87 taken through 88-88.

(FIG. 89 is a perspective view of a section of a ventilation structure usable in the window of FIGS. 86 through 88

FIG. 90 is a front elevational view of a railing support having a solar collector and a weatherproof electrical outlet.

FIG. 91 is a top plan view of the support of FIG. 90.

FIG. 92 is a bottom plan view of the support of FIG. 90.

FIG. 93 is a right-hand elevational view of the support of FIG. 90.

FIG. 94 is a left-hand elevational view of the support of FIG. 90.

FIG. 95 is a cross-sectional view of the support of FIG. 90 taken through 95-95 of FIG. 91 illustrating the connection between the solar collector and the battery and waterproof electrical outlet.

FIG. 96 is a front elevational view illustrating an embodiment of the invention having a solar collector, storage battery and electrical outlet in combination with a wooden sash.

FIG. 97 is a partial cross-sectional illustration of the embodiment of FIG. 96.

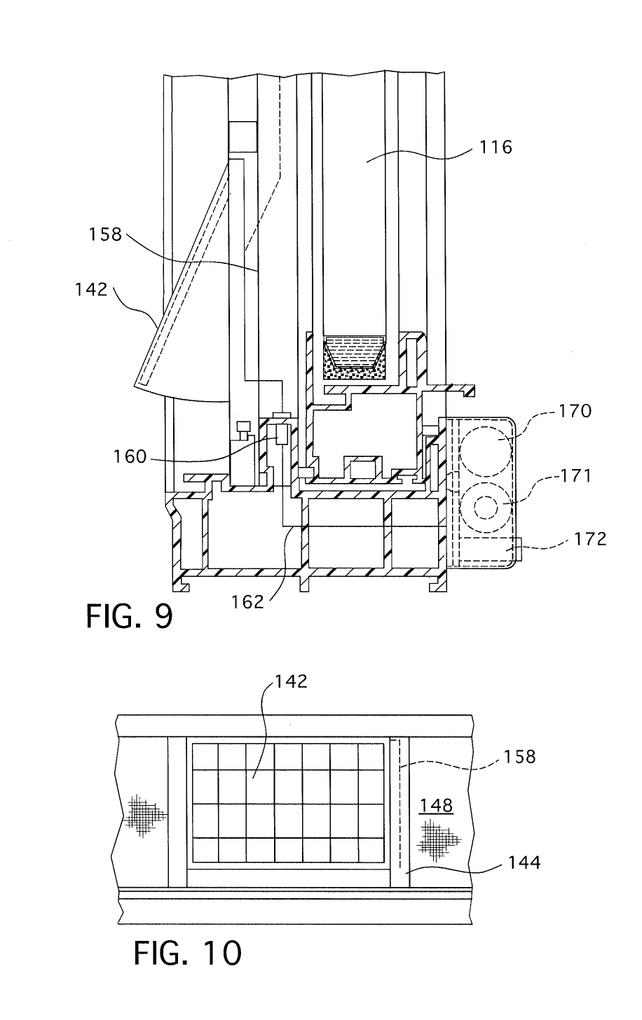

FIG. 9 is an elevational view of a post cap and underlying post (partially broken away).

FIG. 99 is a front elevational view of the post cap shown in FIG. 98.

FIG. 100 is a left-hand elevational view of the post cap of FIG. 98.

FIG. 101 is a right-hand elevational view of the post cap of FIG. 98.

FIG. 102 is a rear elevational view of the post cap shown in FIG. 98.

FIG. 103 is a bottom plan view showing the open post cap partially broken away.

FIG. 104 is a top plan view of the post cap of FIG. 98.

FIG. 105 is a front elevational view of a multiple panel solar collector and its associated housing.

FIG. 106 is a right-hand elevational view of the structure of FIG. 105.

FIG. 107 is a left-hand elevational view of the structure of FIG. 105.

FIG. 108 is a rear elevational view of the structure of FIG. 105 in combination with an associated mounting bracket.

FIG. 109 is a top plan view of the structure of FIG. 105.

FIG. 110 is a bottom plan view of the structure of FIG. 105.

FIG. 111 illustrates the structures of FIGS. 105 through 110 partially in section in the first stage of securement to a support member.

FIG. 112 illustrates the structures of FIG. 111 in the partially secured position.

FIG. 113 illustrates the final secured position of the structures shown in FIGS. 111 and 112.

### DESCRIPTION OF THE PREFERRED EMBODIMENTS

The windows with which the solar powered charging systems of the present invention may be employed may be of a wide variety of constructions. More specifically, the windows may have single, double or triple panes. Also, the frames may be made of any suitable materials such as aluminum, steel, vinyl, fiberglass, wood and composites. The system is readily employed in residential as well as commercial structures. The system may also be employed in new construction, replacement windows as well as field application of the device to pre-existing windows. The system is also usable with doors.

As used herein, the word “exterior” refers to the outside of a building or other structure having a window, window assembly or door of the present invention.

As used herein, the term “interior” refers to the building interior side window of a window assembly or door provided in a building or other structure.

As used herein the term “power outlet” refers to single power outlet or multiple power outlets energized by a storage battery and accessible for purposes of charging a device.

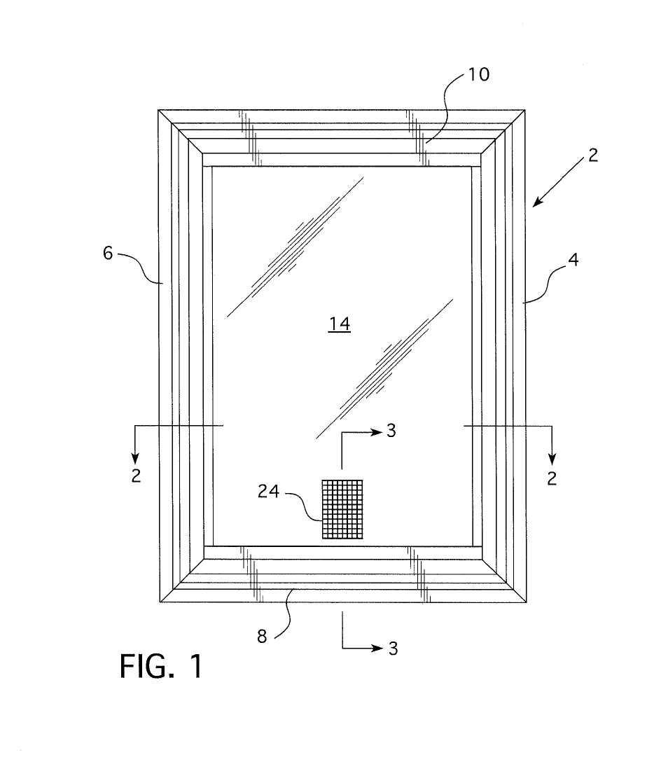

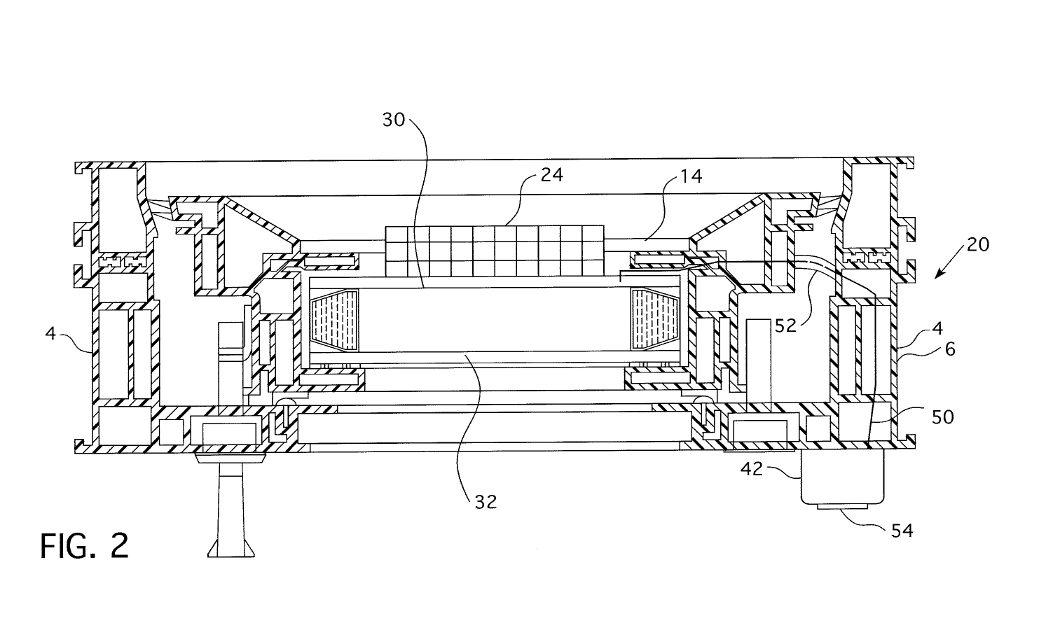

Referring to FIGS. 1 through 2, there is shown a rotatable window which in the form illustrated is structured to rotate about a vertical axis. The concepts of this embodiment are equally employable with windows which are rotatable about a horizontal axis with appropriate positioning of the solar collector in a manner which will be known to those skilled in the art based upon the disclosure regarding FIGS. 1-3.

FIG. 1 shows a vinyl casement window which has a generally rectangularly frame 2 which in the form illustrated is made from vinyl extrusion sections. The frame 2 has a pair of jambs 4 and 6, a sill 8, and a header, 10.

The window in the form shown is a casement window which has a rotatable sash 14 which is rotatable about a vertical hinge 20 as shown in FIG. 2. The hinge is on the right side and the sash 14 would rotate outwardly in a generally clockwise direction. The solar collector 24 is secured to the outer surface 26 of the forwardmost 30 of the two panes of glass contained within the sash 14. The solar panel 24 has its upper edge 36 secured to glass pane 30 by any suitable means such as by an adhesive or mechanical fasteners such as screws, rivets or nuts and bolts, for example.

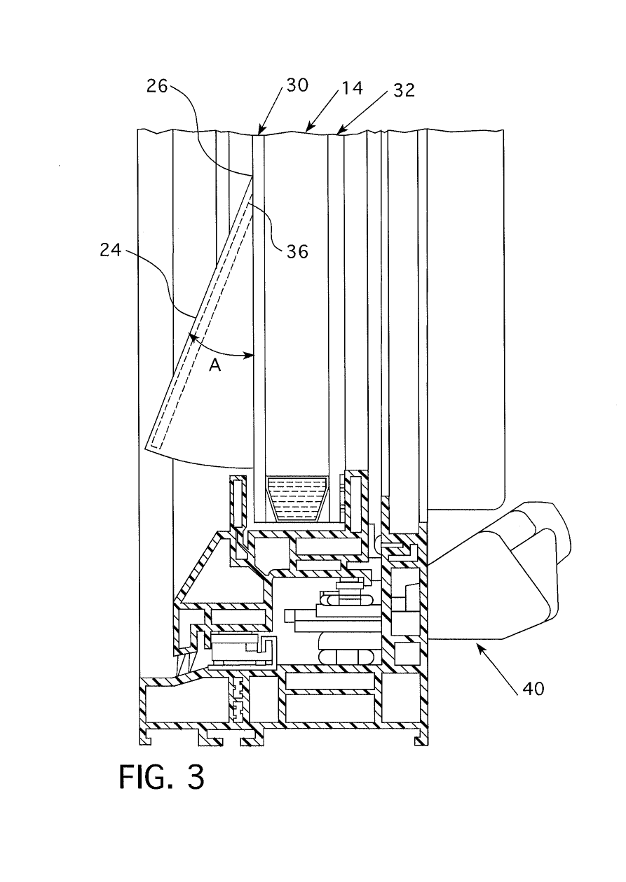

In the form shown, the solar panel 24 extends angularly downwardly and outwardly at a smaller included angle A (FIG. 3) of about 1 to 90 degrees.

This range of angles A is preferred in order to maximize the efficiency of collection of the solar energy by the solar collector 24.

For convenience of shipment, the solar collector may be initially provided may be rotated inwardly in general surface to surface contacts through 3 with the outer surface of glass pane 30. Upon installation, the solar collector will be rotated outwardly to the desired position.

In the form shown in FIGS. 1-3, the window is a casement window which is caused to rotate through operation of the crank assembly 40 in a conventional manner. A preferred combination storage battery and power outlet unit 42 is, in the form shown, attached to the interior surface of jamb 6. An electrical conductor which in the form shown is wire 50, is connected at one end to the solar panel and passes through a flexible plastic tube 52 in order to provide electrical energy created responsive to the solar collector absorbing solar light to charge the storage battery(s), which in turn, is structured to charge whatever device is subsequently connected to it through the power outlet 54. The batteries are preferably AA rechargeable storage batteries and may if desired be wired in series with each other or in parallel. As a function of the size of the solar collector, one may generally employ one to three batteries. One of the advantages of the present system is that a net zero energy window could be provided such that a very large solar collector would supply all of the devices which are to be charged such as USB ports, charging pads, portable batteries and rechargeable batteries. If desired, the USB ports may be retractable. The invention is not limited to the use of AA rechargeable storage batteries, but dependent upon the electrical needs may be other types of batteries and combinations thereof. The power outlet may conveniently be a USB port.

If desired, the frame and sash could each have cooperating electrical components such that the circuit would be completed when the window is in a closed position.

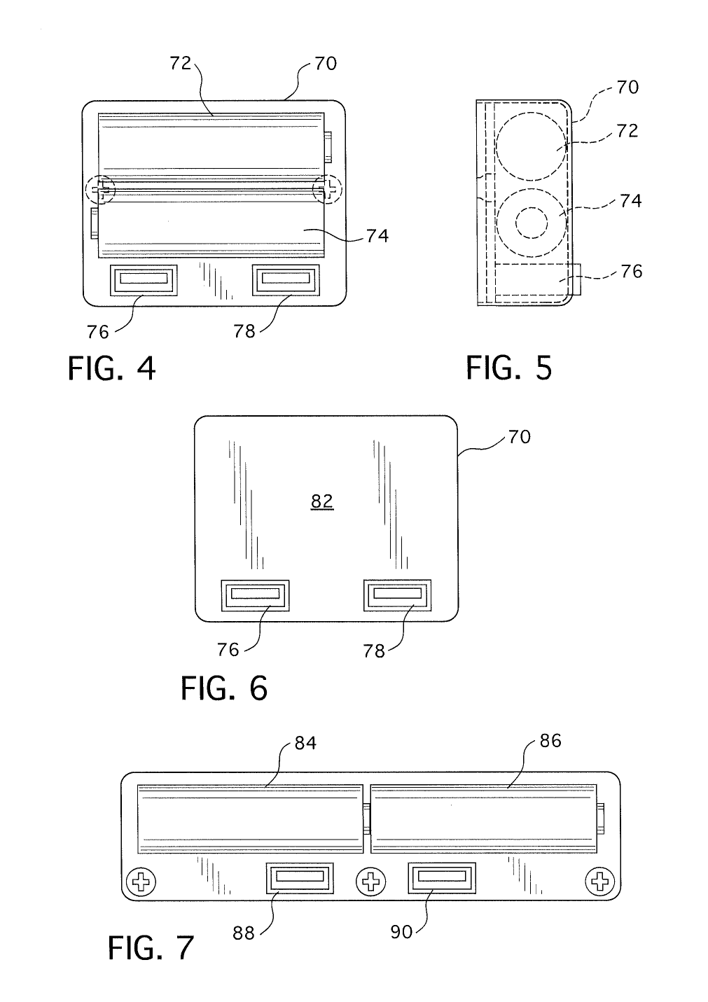

Referring to FIGS. 4 and 5, there is shown a housing 70 containing a pair of storage batteries 72, 74 which are electrically connected to the solar collector 24 through wire 50 in a conventional manner (not shown in this view). The storage batteries 72-74 each serve to energize a power outlet 76, 78, respectively, through conventional wiring (not shown). The assembly shown is shown with its cover 82 in place in FIG. 6. It will be appreciated that, in this manner, the solar collector 24 receives light, converts it to electricity, which through wire 50 is delivered to and charges storage battery 72,74 with access to charging a device being obtainable through power outlets 76, 78. The batteries 72, 74 are preferably contained within a protective housing, such as housing 70, and also may be placed within a void within the window frame as contrasted with projecting outwardly from the inside of the window.

FIG. 7 shows an alternate embodiment for a housing for the storage batteries and the power outlets, which, in the form shown, are USB ports. The batteries 84, 86 are shown in side by side relationship as contrasted with vertically stacked arrangement of FIGS. 4 and 5 with the associated USB ports 88, 90. This embodiment is better suited to use with window and door structures which have a low sill height.

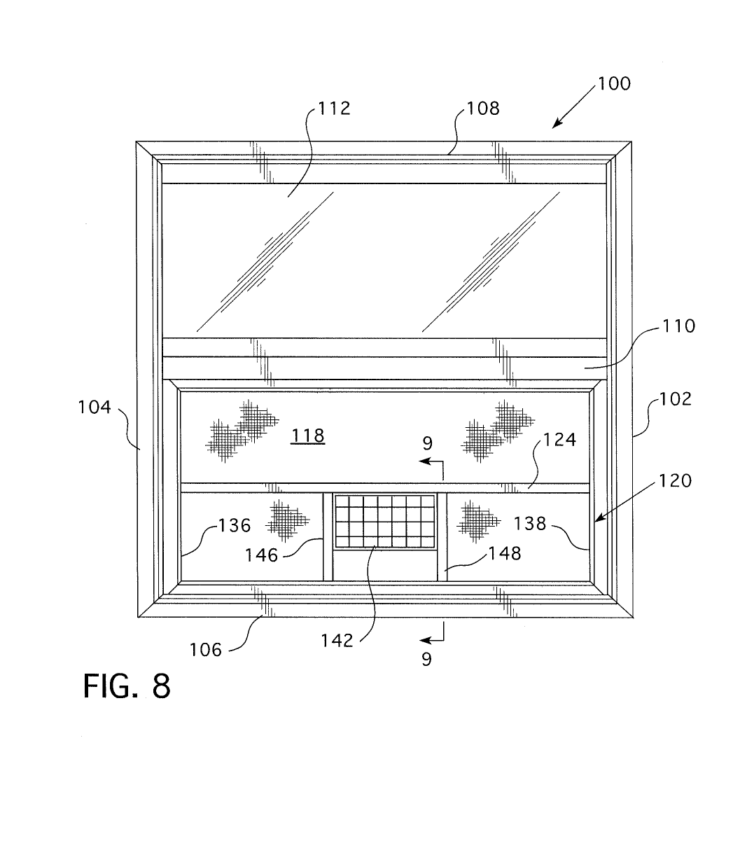

FIGS. 8 through 10 show a front elevational view of a window 100 having a frame consisting of a pair of extruded jamb sections 104 to which a rail 106 is joined at the lower extremity and a header 108 is joined at the upper extremity. A fixed lite 112 is disposed over a moveable sash 116 (FIG. 9). Mullion 110 is interposed between fixed lite 112 and sash 116. A screen 118 has a frame 120 and a rail 124 having opposed ends fixedly secured to screen frame members 136, 138. A solar collector 142 is fixedly secured to the screen by support members 146, 148. As shown in FIGS. 9 and 10, tubular support 148 is hollow and has a wire 158 which is connected to the solar collector 142 for delivery of electrical current from the solar collector 142 to electrical connector 160 and through wire 162 to the storage battery 170 and USB port 172. It will be appreciated that, in this manner, efficient delivery of electricity generated by the solar panel 142 is delivered through wires 158 connector 160, wire 162 to the storage battery to charge the same with the battery in turn providing energy for the USB port 171. The sash window 116 may be reciprocated vertically without mechanical interference with the solar collector system.

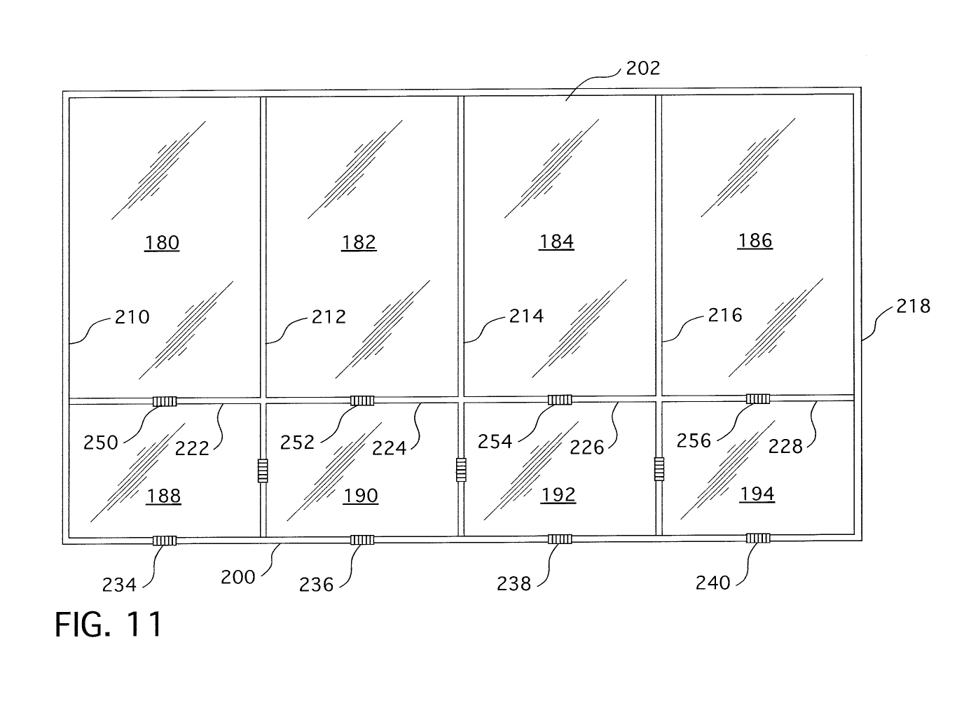

Referring to FIG. 11, there is shown a storefront assembly of a plurality of fixed panels 180, 182, 184, 186, which overlie respectively a second plurality of fixed panels 188, 190, 192, 194. These panels may be windows or decorative panels of various sorts, for example, and be made of various materials. The framing members consist of a sill 200 and header 202 with a plurality of vertical support elements 210, 212, 214, 216. A plurality of rail elements 222, 224, 226, 228 are secured respectively to framing members 210 to 212, and 212 to 214 and 214 to 216 and 216 to 218. While the framing members may be made of any material possessing the desired strength, durability and other properties for purposes of example, in the present context, they will be considered as being aluminum extrusions which are connected to each other in any suitable conventional manner. A plurality of solar collectors 234, 236, 238, 240 of the present invention are secured to rail 200 at spaced locations and are generally centrally located underlying respectively panels 188, 190, 192, 194. Similarly, solar collectors 250, 252, 254, 256 are respectively interposed between panels 180, 188, and 182, 190 and 184, 192 and 186, 194. This provides this collector wall with eight distinct independent solar collectors for charging their respective storage batteries and permitting a device to be charged to have access to each of the power outlets such as USB ports.

If desired, the output from the various solar collectors may be connected to one or more electrical bus members to provide an efficient means of delivering the electrical energy to the electrical outlets.

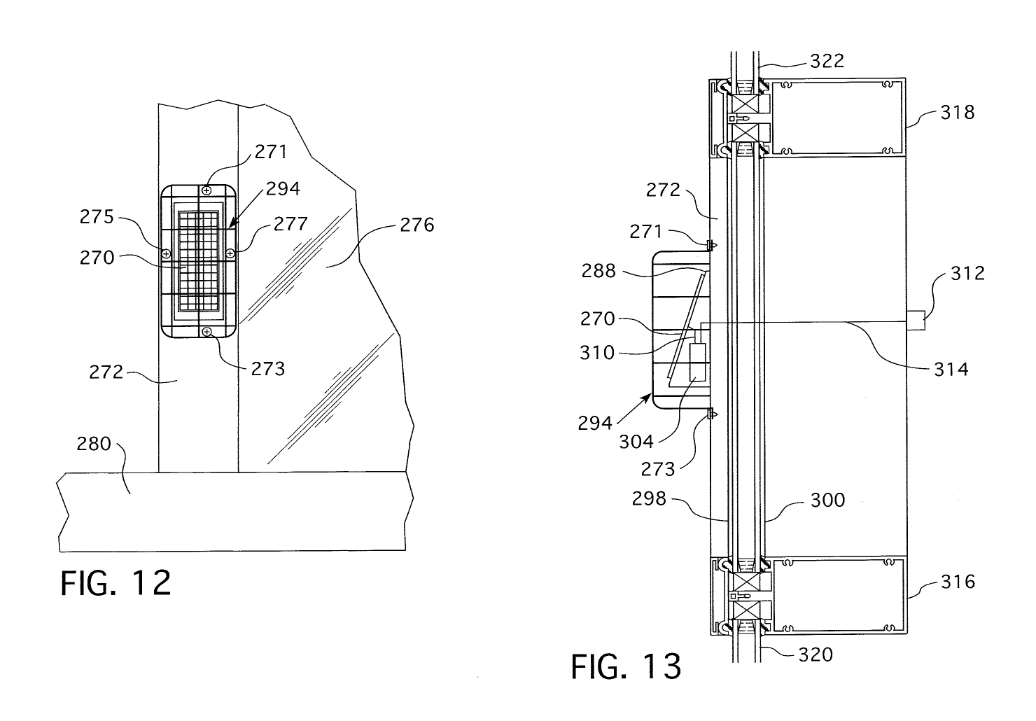

Assuming for purposes of illustration that the panels are glass panels, with reference to FIGS. 12 and 13 additional features of the invention will be considered.

The solar panel 270 is secured to a vertical framing member 272 and extends downwardly and outwardly therefrom. For security purposes, a wire cage 294 has been shown as being protectively surrounding the solar collector 270 so as to resist efforts to vandalize the same. This cage may be secured to vertical framing member 290 by any suitable means, such as screws 271, 273, 275, 277.

As shown in FIG. 13, the fixed window consists of two panes 298, 300.

In the embodiment as shown in FIG. 13, the storage battery 304 is disposed on the exterior of the panels 298, 300 and closely behind the solar collector 270. An electrical conductor which in the form shown is a wire 310, delivers electricity from the solar panel 270 to the storage battery 304. The USB power outlet 312 is secured to the interior of rear surface of the mullion 290 and is connected to the storage battery 304 by wire 314 which passes through the mullion.

Horizontally oriented hollow aluminum extrusions rails 316, 318 respectively support underlying two pane window 320 and overlying two pane window 322. It will be appreciated that in this embodiment, the storage battery has been positioned exteriorly of the structure and the USB power outlet interiorly. Also, a vandal resistant wire basket 294 has been positioned around the solar collector 270 and storage battery 304.

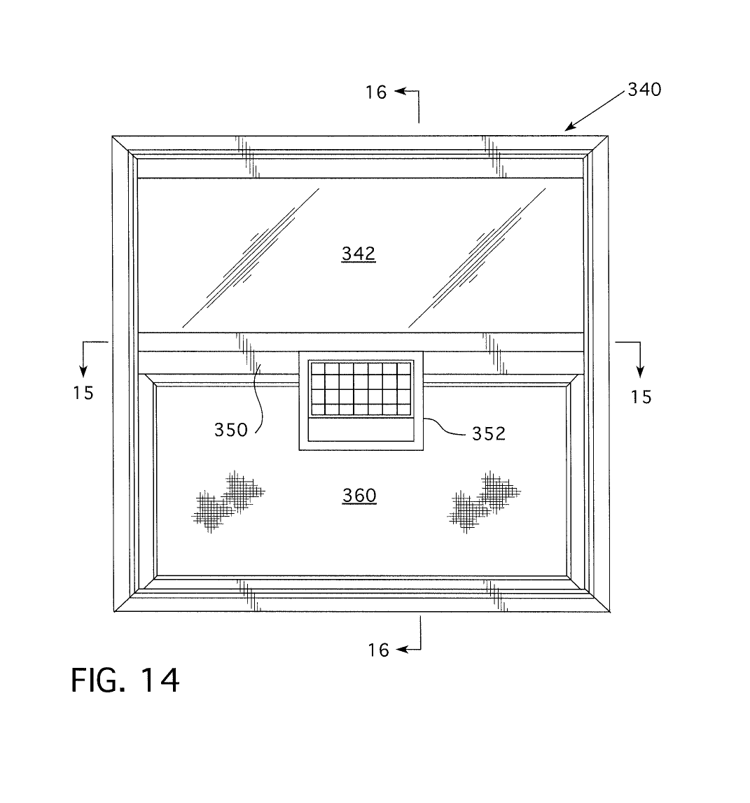

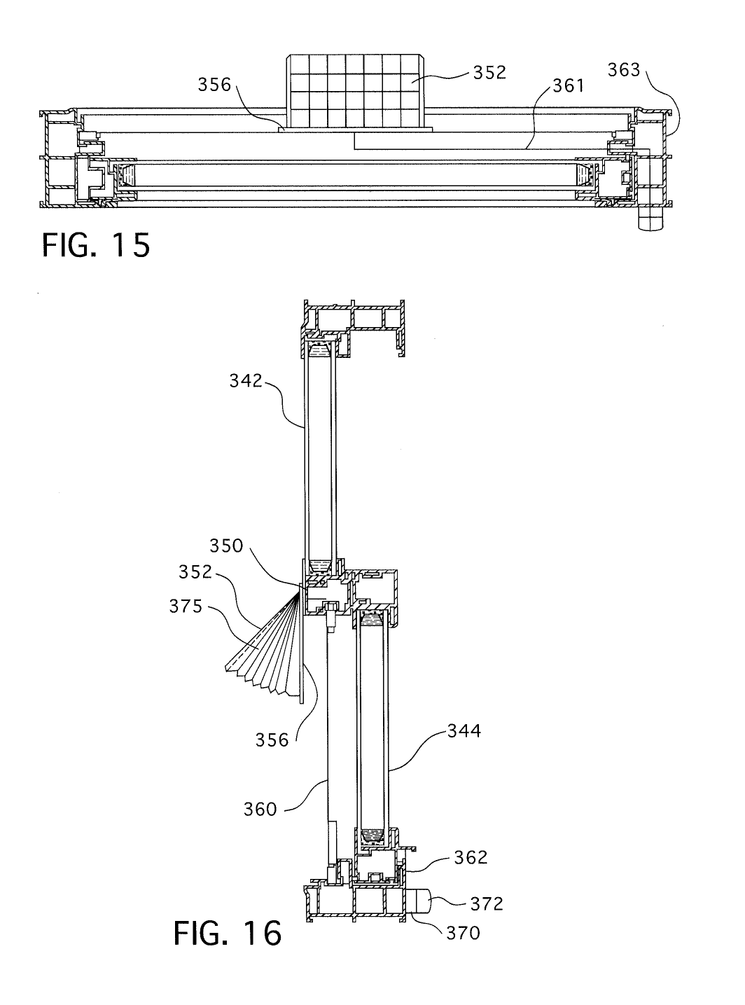

Referring to FIGS. 14 through 16, there is shown a window frame 340 having a fixed lite 342 and a movable sash 344 with a hollow rail 350 to which a solar collector 352 is secured by and is generally coextensive with a support plate 356 which in turn is secured to the hollow rail 350, an electrical wire 361 which is connected to the solar collector 352 extends through hollow rail 350 and downwardly through frame 363 and is electrically connected to the storage battery 370 which in turn energizes the USB port 372.

Another feature of this embodiment of the invention is the bellows type housing 375 (FIG. 16) which allows for adjustment of the position of the solar collector and collapse of the same toward support plate 350 for shipment. The bellows may be made of any suitable material such as polyvinyl chloride, polycarbonate, nylon, or metal, for example.

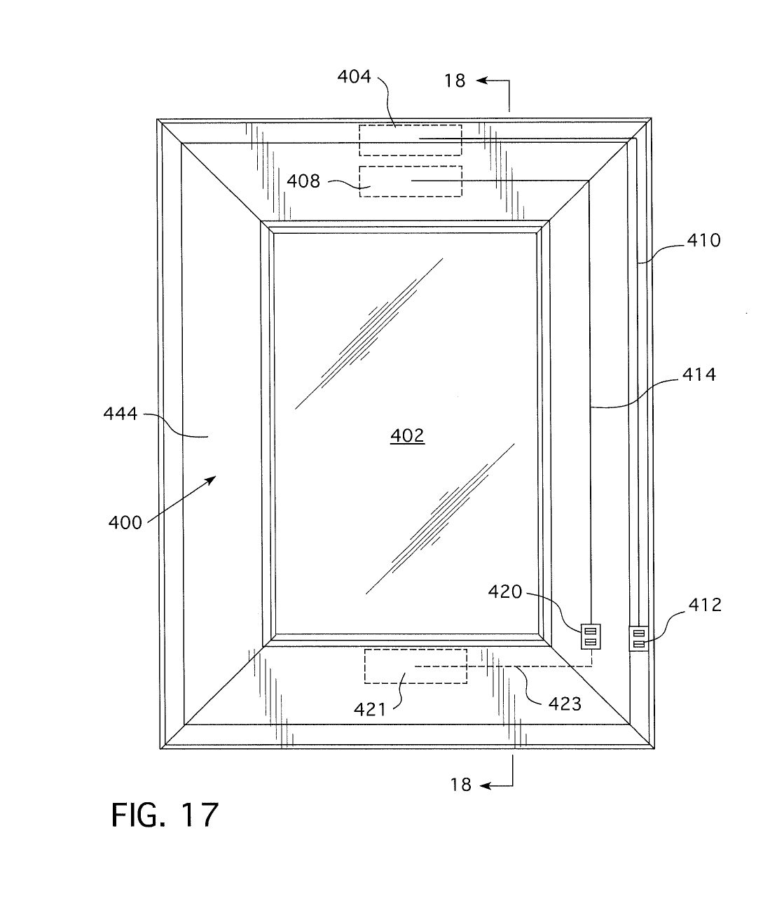

FIGS. 17 through 19 relate to a rotating a swing-door 400. FIG. 17 shows a front elevational view from the interior of the building. The door has a rotatable sash 402 fixed to the frame for rotation therewith. In the embodiment shown, the system has three solar collectors, one of which 404 is secured to the door frame, and the others of which 408, 420 are secured to the door sash. Solar collector 404 collects solar energy and, by means of wire 410, delivers the energy to the battery (not shown) which is disposed rearwardly of the two USB power outlets 412 which are energized by the battery. Depending upon the electrical power requirements, each of the solar collectors, 404, 408, 421, would be associated with one of the two USB power outlets with each of the two USB power outlets 412, 420 being energized by a separate battery or batteries. In this manner, someone on the inside of the building can readily access the two USB power outlets to employ the electrical energy resulting from the exteriorly disposed solar panel 404. Similarly, exteriorly positioned solar panel 408 delivers current through wire 414 to the storage battery (not shown) but positioned rearwardly of the two USB power outlets 420. Wires 410 and 414 are disposed on the interior of the door frame. A second solar collector 421 may be positioned on the sash at the lower end thereof on the exterior and through an external wire 423 deliver electrical energy to the battery (not shown) which is behind the USB port 424 and energizes the same. It will be appreciated that for a given installation, more or less than the number of solar collectors 404, 408 and 421 shown in FIG. 17 may be used and, depending upon preference, could be positioned on the frame or the sash over both.

It will be appreciated that similar systems as disclosed and illustrated in connection with the doors of FIG. 17 through 19 may be employed with tilt and turn Window and door constructions.

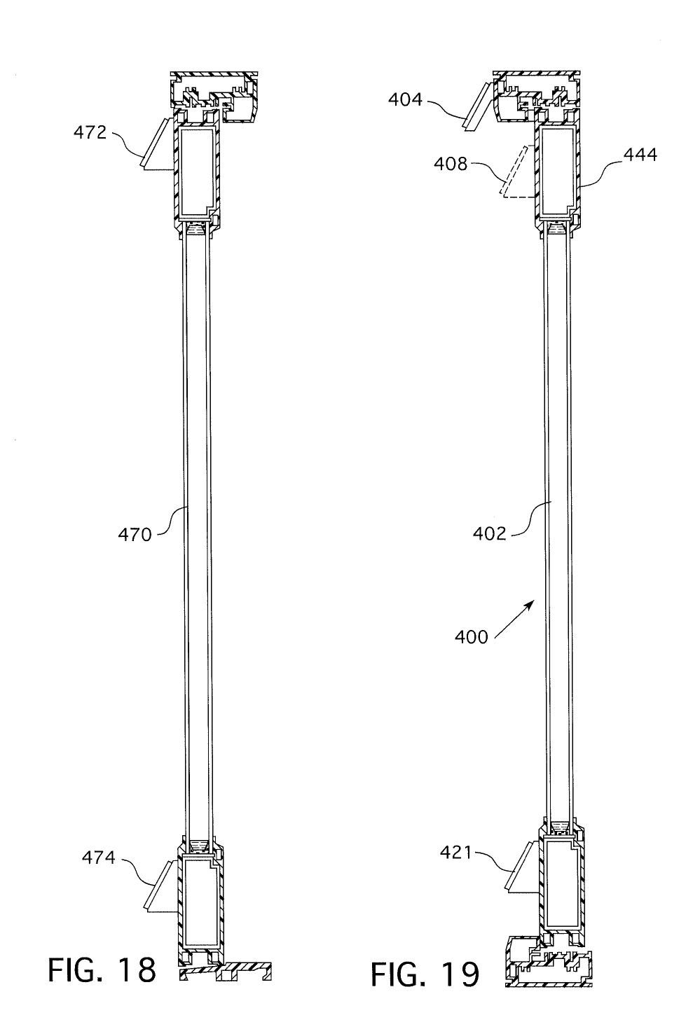

FIG. 18 shows in section the construction for the door 400 of FIG. 17 which is structured to swing into the building. It has sash 402 secured within a frame 444, a sash mounted solar collector 408 is secured exteriorly of the door as is a frame mounted solar collector 404. A second sash mounted solar collector 421 is at the lower end of the sash 402. The electrical energy provided by solar collectors 404, 408, 421 are presented to the storage batteries which in turn energize the USB power outlets.

Referring to FIG. 19, this illustrates an out-swinging vertical section with the sash 470 having an upper solar collector 472 secured to the exterior thereof and a second solar collector 474 secured to the exterior at the lower end of sash 470. Wired connections and the storage batteries being charged thereby along with the USB power outlets which they energize may be similar to those discussed in connection with FIG. 17. As was true with respect to FIG. 17, the number and positioning with the solar collectors 404, 408, 421, 472, 474 may be varied in terms of number, positioning on the sash, the frame or both, depending upon the design perimeters employed.

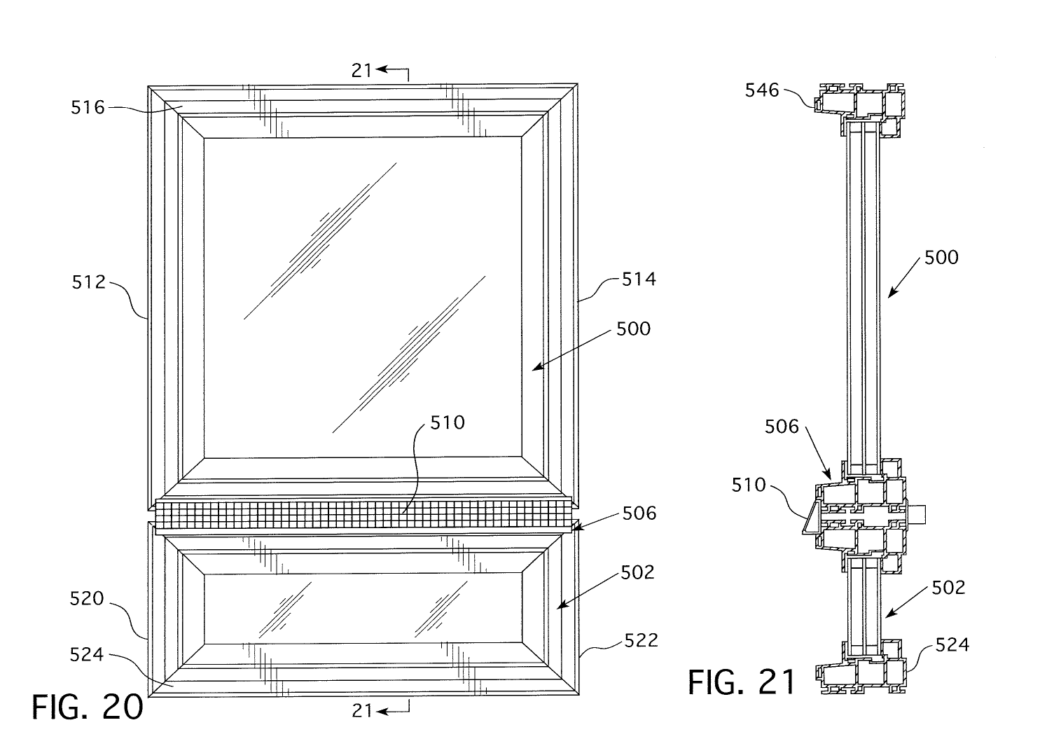

Referring to FIGS. 20 and 21, there is shown a window assembly having an upper window 500 and a lower window 502 and a mullion 506 is disposed in between upper window 500 and the lower window 502. In the form illustrated, a solar collector 510 is secured to the mullion 506 and is substantially coextensive therewith. In a preferred form, the solar collector 510 would have a width in the range of about 4 inches to 100% of the width of the mullion. The upper window 500 is secured between the mullion 506 and jambs 512, 514 and header 516. The lower window 502 is secured between the mullion 506, jambs 520, 522, and sill 524.

In the form shown in FIGS. 20 and 21, the framing members are vinyl extrusions although, if desired, other materials such as aluminum or fiberglass, for example, may be employed.

The solar panel 510 extends downwardly and outwardly from the mullion 506 and preferably has an included angle therebetween about 1 to 90 degrees with respect to the vertical.

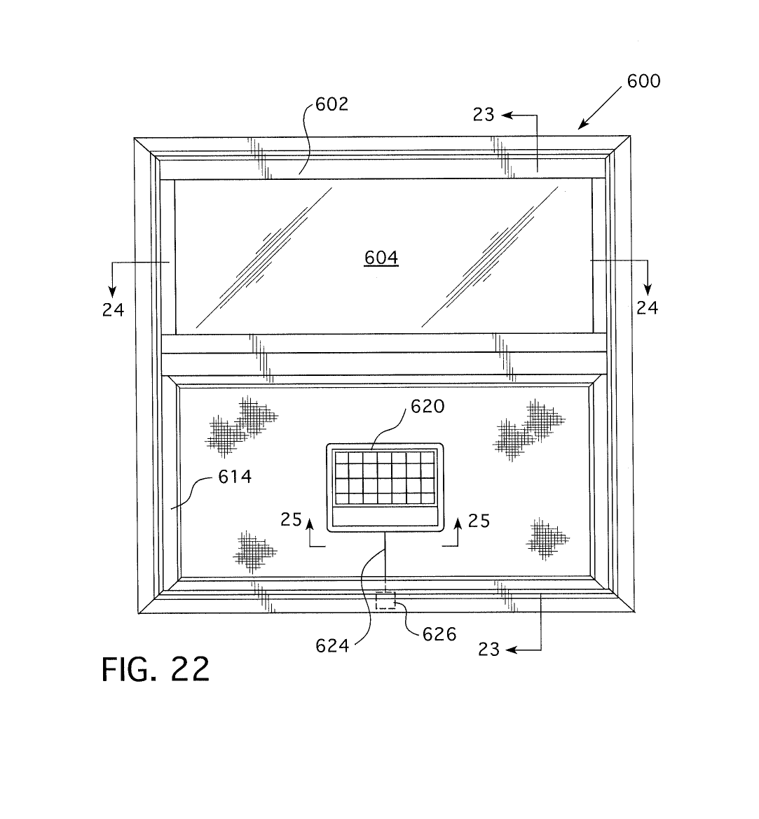

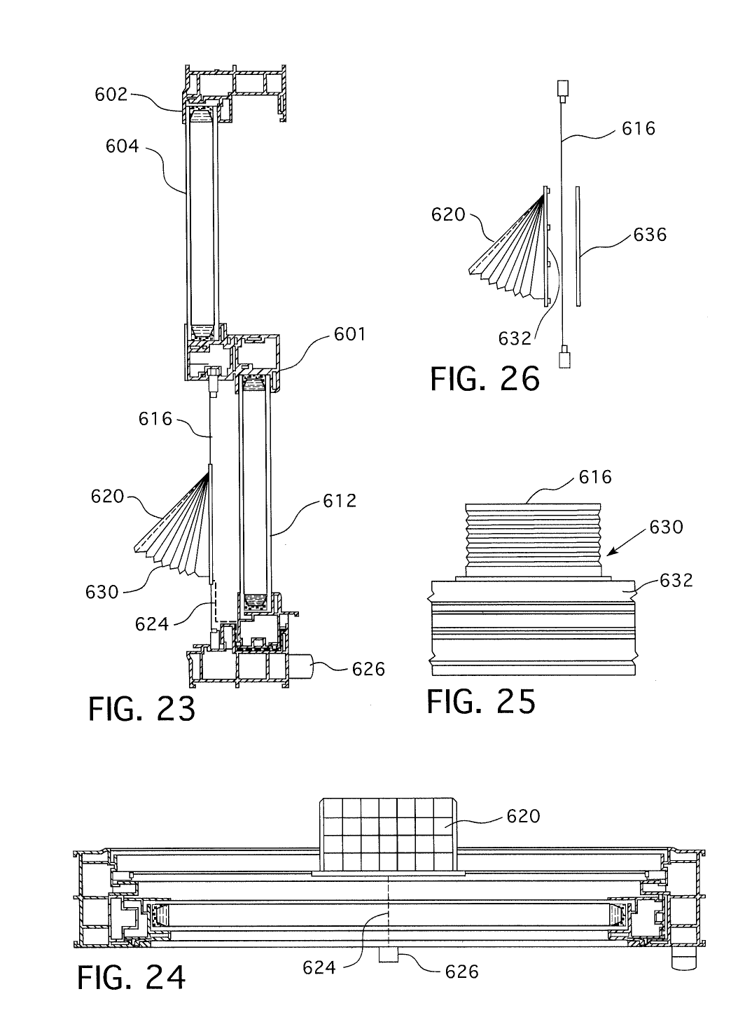

Referring to FIGS. 22-25, there is shown a single hung window 600 having a fixed upper lite 602 with a double pane glazing 604. A movable sash 601 has a double pane glazing 612. Secured within the frame 614 is a screen 616. A solar collector 620 projects outwardly and downwardly from the screen 616 to which it is secured. The solar collector which is secured to the exterior of the window-screen assembly has an electrical wire 624 and its associated storage battery which may be positioned on the interior of the window-screen assembly or within spaces on the inside of the assembly with the USB port being open rearwardly for access from the interior of the structure. In the form shown, a bellows 630 is secured to the underside of the solar collector 620 so as to resist undesired entry of insects into the region between the screen and rear surface of the solar collector 620.

Referring to FIGS. 26 through 28, a preferred manner of securing the solar collector 620 to the screen 616 will be considered. The solar collector 620 is secured to the bellows 630, which in turn is secured to base element 632 which is positioned exteriorly of the screen 616. Disposed on the inside of the screen is a support plate 636 which cooperates with base 632 in accepting securement of the solar collector 620 and bellows 630 to the screen. In this embodiment, which may advantageously be employed to retrofit a solar collector system into an existing window-screen assembly, the base member will have a plurality of rearwardly projecting posts, such as 640,642,644,646,648,650,652,654, which are distributed about the periphery of the rear surface of the support of the base 632.

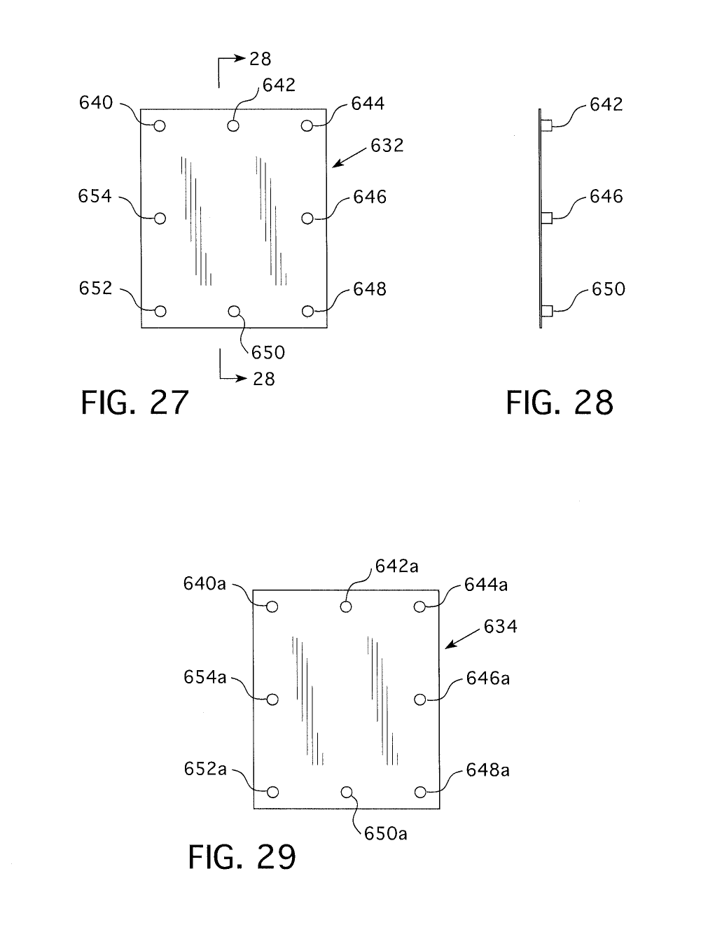

FIGS. 27 and 28 show the base 632 which has around its perimeter a plurality of outwarding projecting posts 640,642,644,646,648,650,652,654.

FIG. 29 has a plurality of openings 640a,642a,644a,646a,648a,650a,652a and 654a which correspond in dimension and position to the posts of FIG. 28. It will be appreciated that as shown in FIG. 26, the solar collector 620 and bellows 632 which are secured to base 632 are positioned on the exterior of screen 616 and cooperating support member 636 is positioned on the interior. By urging the two members 632,634 together, effective securement of the solar collector 620 to the screen 616 is effected. In a preferred embodiment, adhesive will be applied to the inward facing surface of base 630 or outward facing surface of member 634, or both, in order to provide for more intimate securement.

Referring to FIG. 29, there is shown a plurality of holes 640a,642a,644a,646a,648a,650a,652a and 654a which are so sized and positioned as to achieve intimate interfit with the posts shown in FIGS. 27 and 28. This will serve to effect intimate securement of the solar collector assembly to the screen.

Another feature of the present invention is a preferred structure which permits rotation of the solar collector, such that it may be shipped initially generally flush with the window or door to which it is attached and may be rotated outwardly to the an angle to permit more efficient receipt of the solar energy. In the present embodiment, selected for purposes of illustration, the solar collector is structured to have two positions. A first position is generally flush with the window or door to which it is secured, and a second position has the solar collector oriented generally downwardly and outwardly to provide a desired angle for exposure to the solar energy.

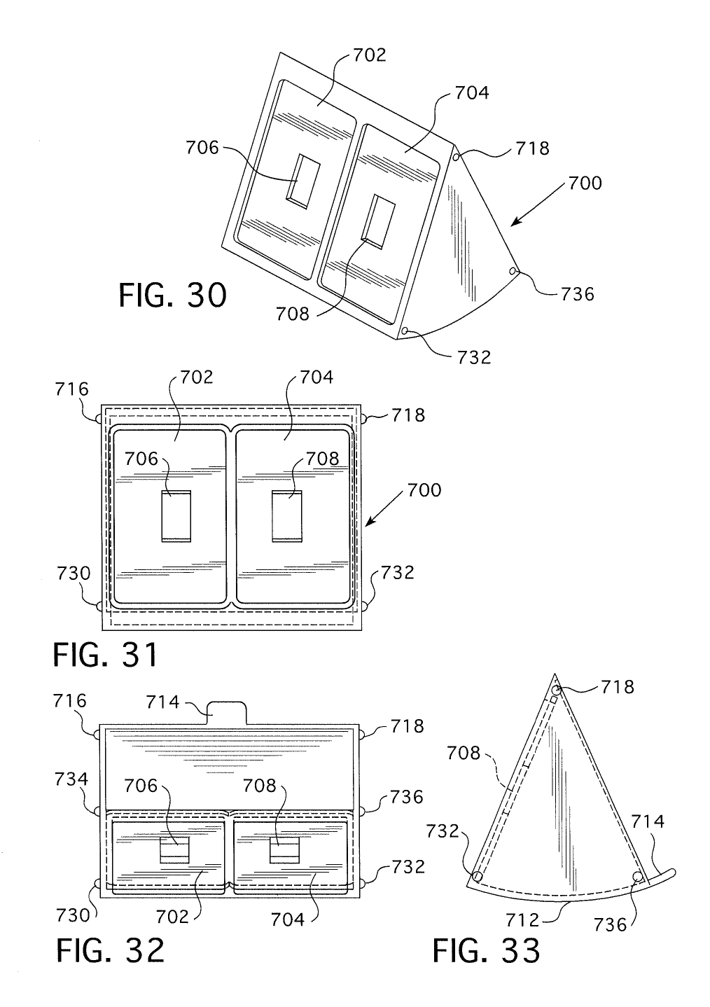

Referring to FIGS. 30 through 33, there is shown a generally wedged shaped solar collector support 700. The support has two recesses 702,704, each of which is structured to receive a solar collector (not shown). The recesses 702,704 have openings 706,708, respectively to permit electrical wires connected to the solar collectors deliver the electrical energy emerging from the solar collectors. The lower portion 712 of the solar collector support 700 is curved and has a projecting tab 714 which may be grasped to facilitate rotation of the solar collector. At the upper end of the solar collector support 700 are a pair of projecting bosses 716,718 which will serve when anchored within the frame as described herein as the pivots for rotation of the solar collector support. At the lower end of the solar energy support are two pairs of outwardly projecting bosses 730,732 and 734,736. The solar collector support 700, when secured to the frame as hereinafter described, can be pivoted about outwardly projecting bosses 716,718 which are engaged with detents (not shown in this view) of the frame. The solar collector support 700 may then, in the form shown, be positioned in a first position wherein the bosses 730,732 are engaged within detents and the solar collector is generally against the supporting surface, or a second position where the bosses 734,736 are engaged within the detents and the solar collector will be projecting outwardly and downwardly. It will be appreciated that additional bosses maybe provided in order to permit fixing the solar collector a number of different angles.

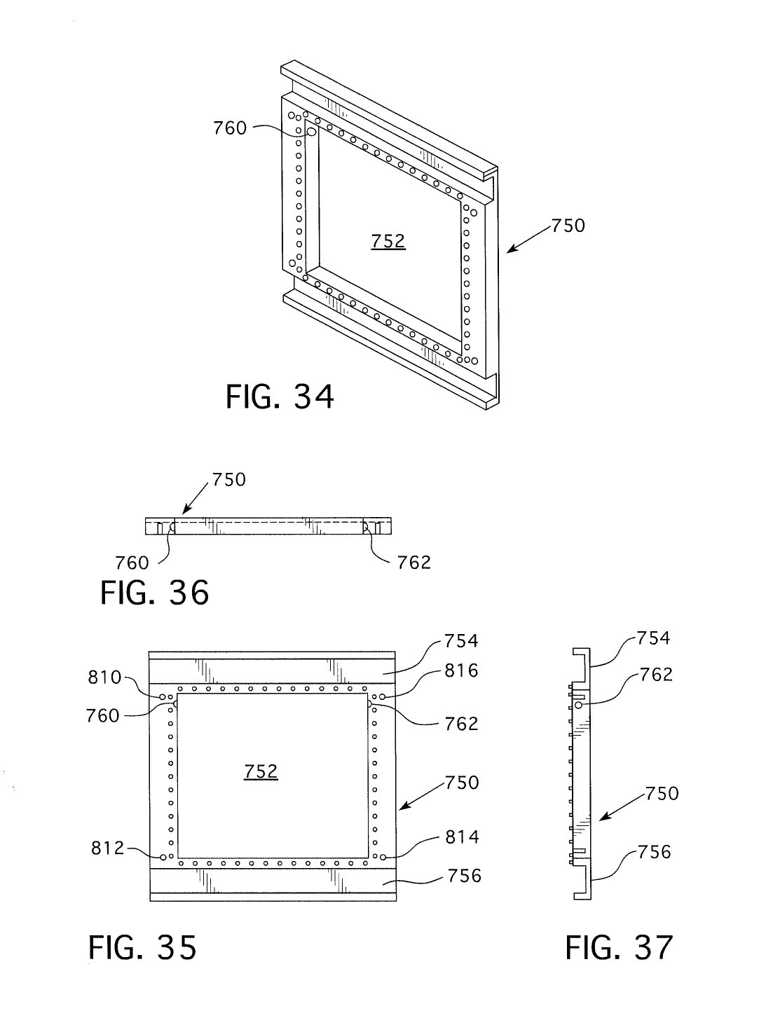

Referring to FIGS. 34 through 37, the frame element 750 has a central opening 752 and a pair of channels 754,756 located at the upper and lower extremities of the frame and having openings facing in generally the same direction. Toward an upper portion of the frame element 750 are a pair of detents 760,762 which are in communication with frame opening 752. The pivot bosses 716,718 of the solar collector support will be received in these detents 760,762 to permit ready rotation of the solar collector support with respect to the frame element 750.

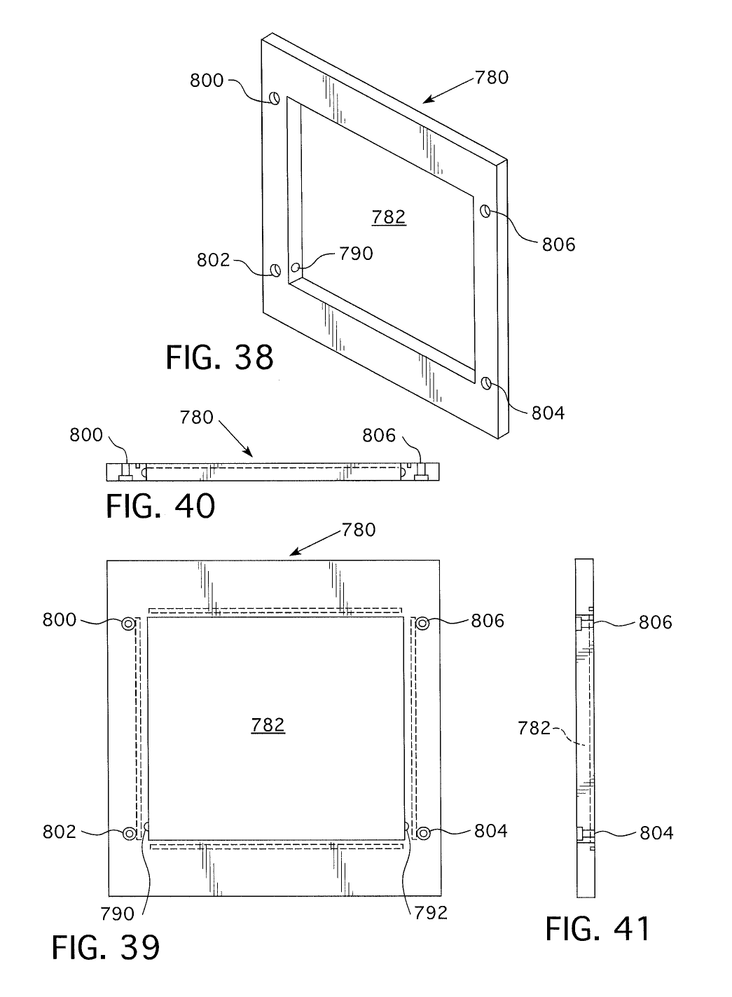

Turning to FIGS. 38 to 41, there is a frame element 780 which has opening 782 and detents 790, 792. It also has openings 800, 802, 804, 806.

Suitable mechanical fasteners such as properly sized screws may be employed to secure the two frame elements 750,780 together.

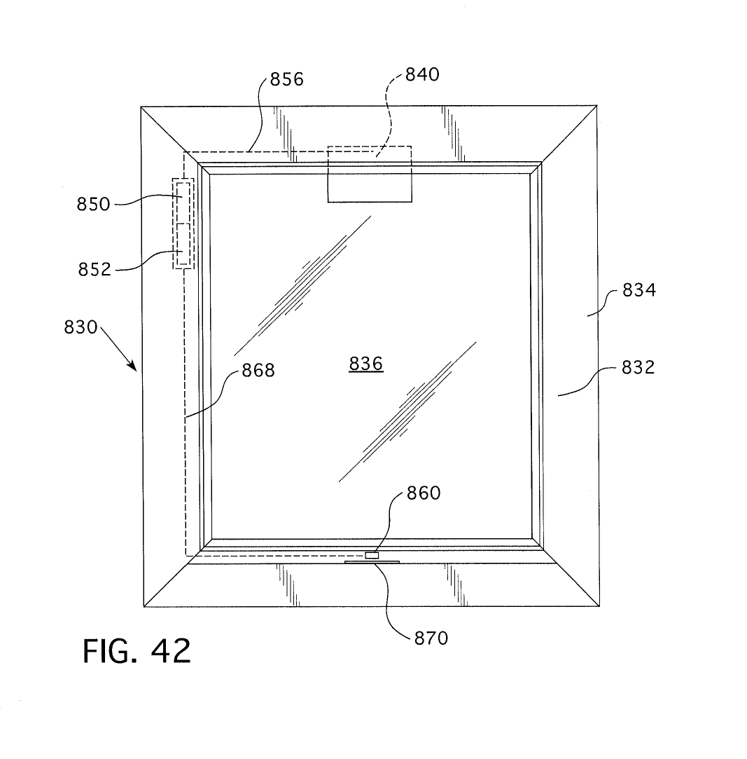

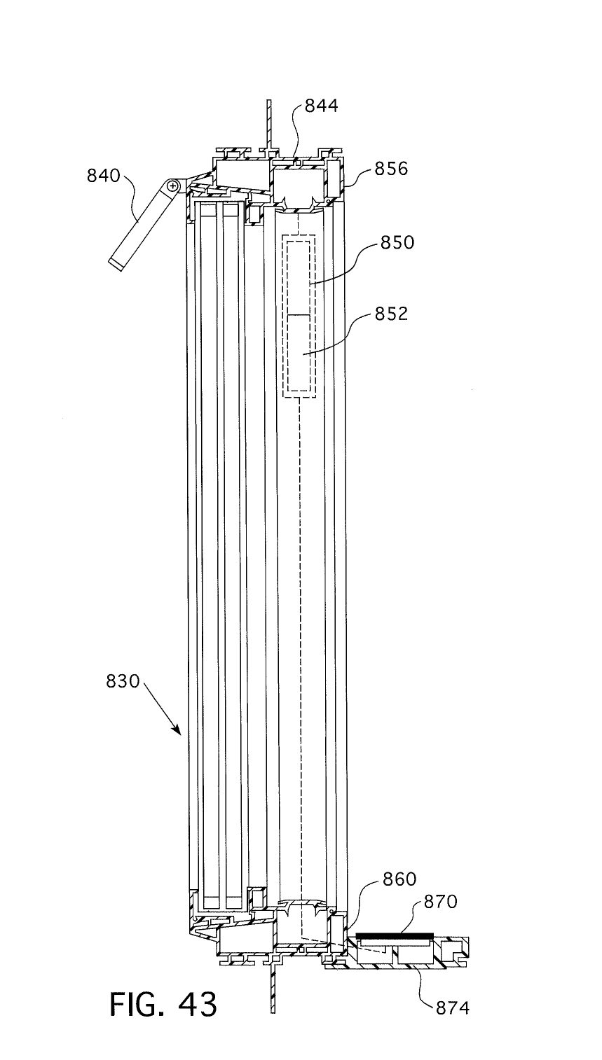

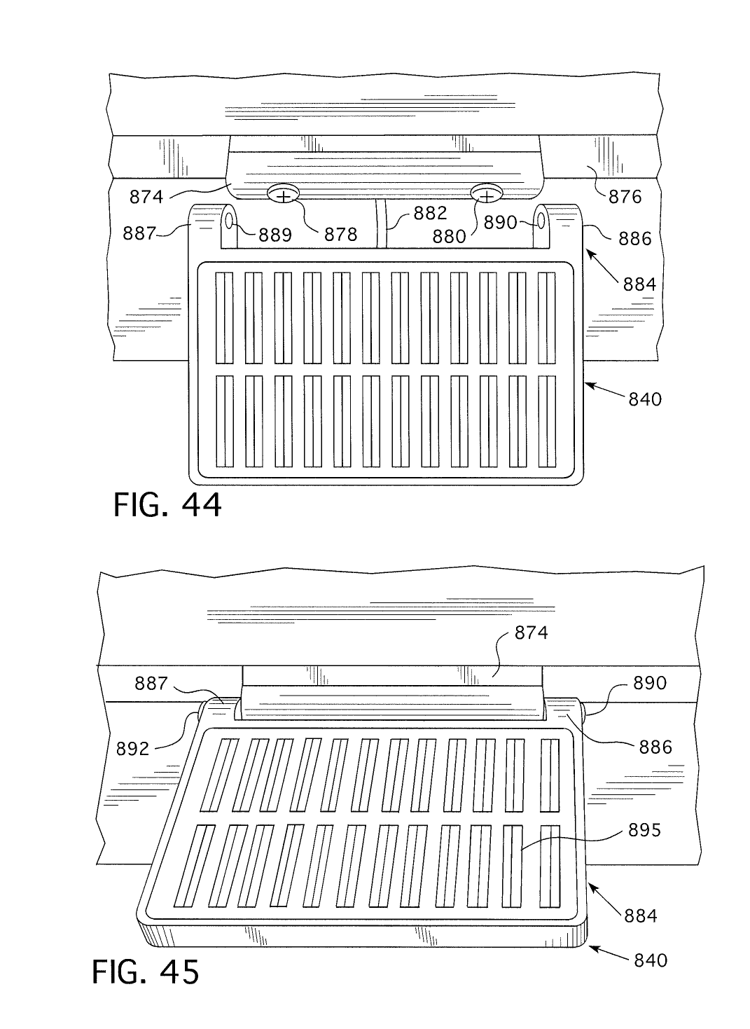

FIGS. 42 and 43 show a fixed window 830 having a frame 834 and double pane glazing 836 secured within the frame 832. A solar collector 840 extends downwardly and outwardly on the exterior of the window from an upper portion thereof adjacent header 844. A pair of storage batteries 850,852 are electrically connected through wire 856 to the solar collector and for receipt of electrical energy therefrom. Batteries 850,852 are connected to electrical outlet which in the form shown is a USB battery 860 through wire 868. In addition to permitting one to connect the charger with the electrical outlet 860 by inserting an appropriate jack therein, this embodiment of the invention provides a wireless charging pad 870 which will facilitate wireless charging of a device. In the form shown, the wireless charging device 870 is secured within the projecting sill 874. A devise to be charged would have an attachment which would complete the circuit when it comes in contact with the charging pad 870.

Referring to FIGS. 44 through 46, the rotatable solar collector 840 will be considered in greater detail. As shown in FIG. 44, the solar collector base 874 is secured to a portion of the window frame 876 by a pair of screws 878, 880 with the wire 882 emerging from the solar collector 840 passing extending through or under the base 874. The solar collector frame 884 has a pair of rearwardly extending legs 886, 887, each of which has a passageway 889, 890.

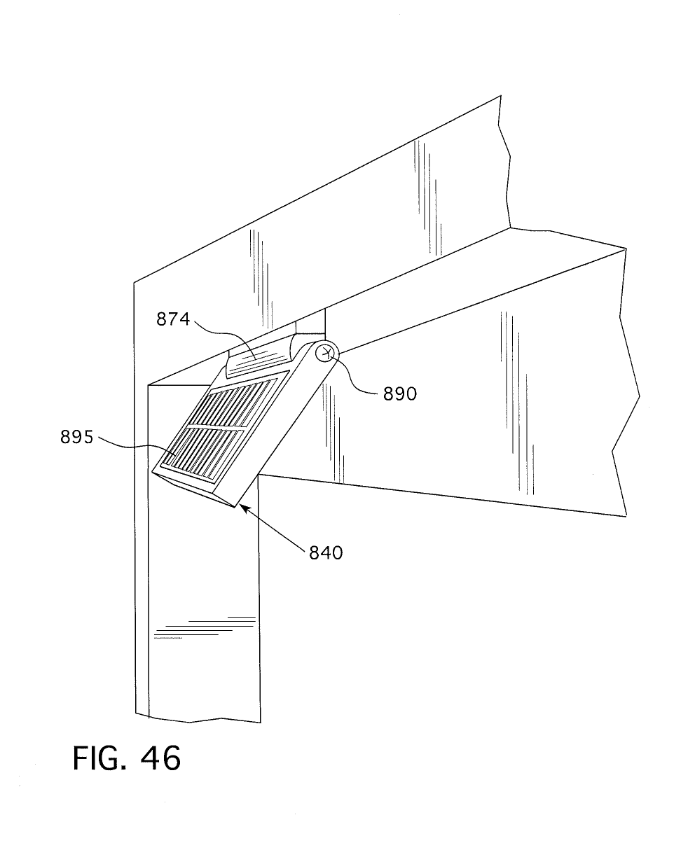

Referring to FIGS. 45 and 46, the legs 886, 887 are aligned with the solar collector frame 884 with mechanical fasteners such as screws 890, 892 passing through legs 886, 887, respectively, and secured within base 874. The solar collector portion 895 is, therefore, rotatably secured to base 874.

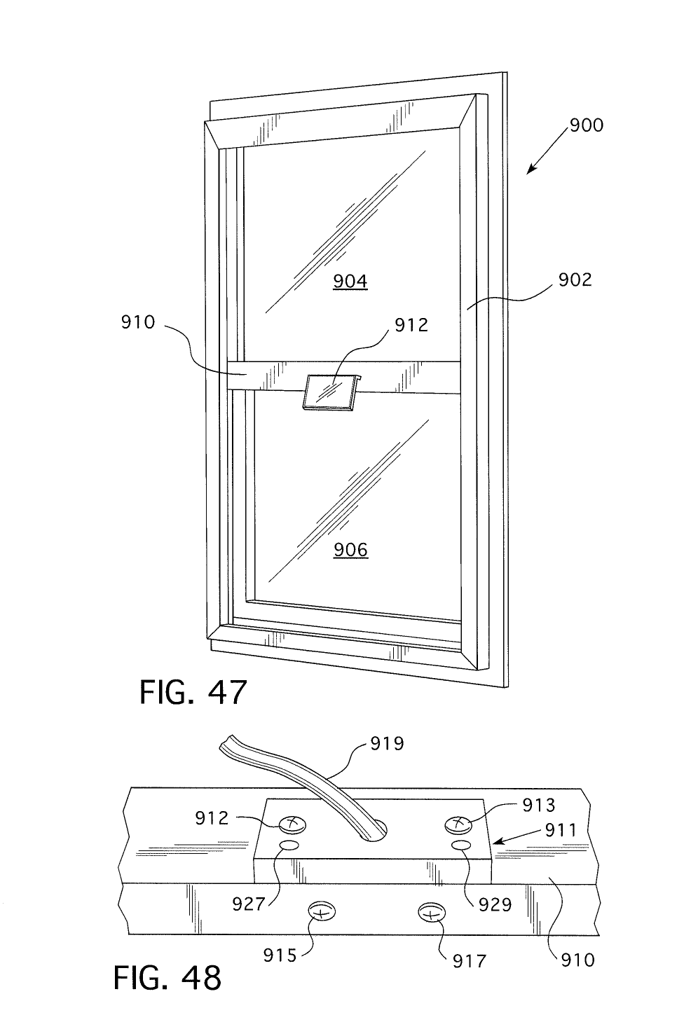

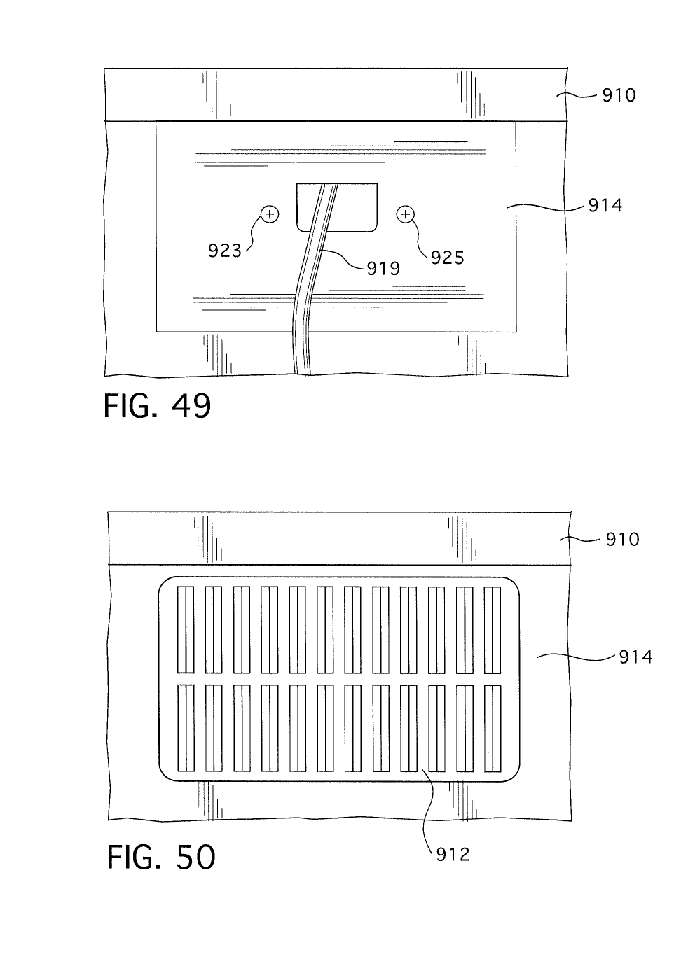

Referring to FIGS. 47 and 48, there is shown a mullion 910 to which is secured anchor member 911 which has two screws 912, 913 securing the anchor member 911 to one surface of mullion 910 and screws 915, 917 securing the anchor 911 to another surface of mullion 910. An electrical wire 919 extends through the anchor 911 to deliver electrical energy emerging from the solar collector 912 through the support 914 into mullion and therebeyond to the storage battery (not shown).

Referring to FIGS. 48 and 49, the solar collector support 914 has an opening 921 through which the wire 919 passes. Support 914 is secured to the anchor 911 by screws 923, 925 which respectively are received in openings 927, 929.

As shown in FIG. 50, the support 914 has the solar collector 912 secured to the outer face thereof as by a suitable adhesive.

The solar collector 912 is generally planar and is secured to a substantially rigid base 914. Fastening screws 920,922,924,926 secure the solar collector 912 and its substantially rigid support 914 to the mullion 910. This provides for a fixed angle solar collector.

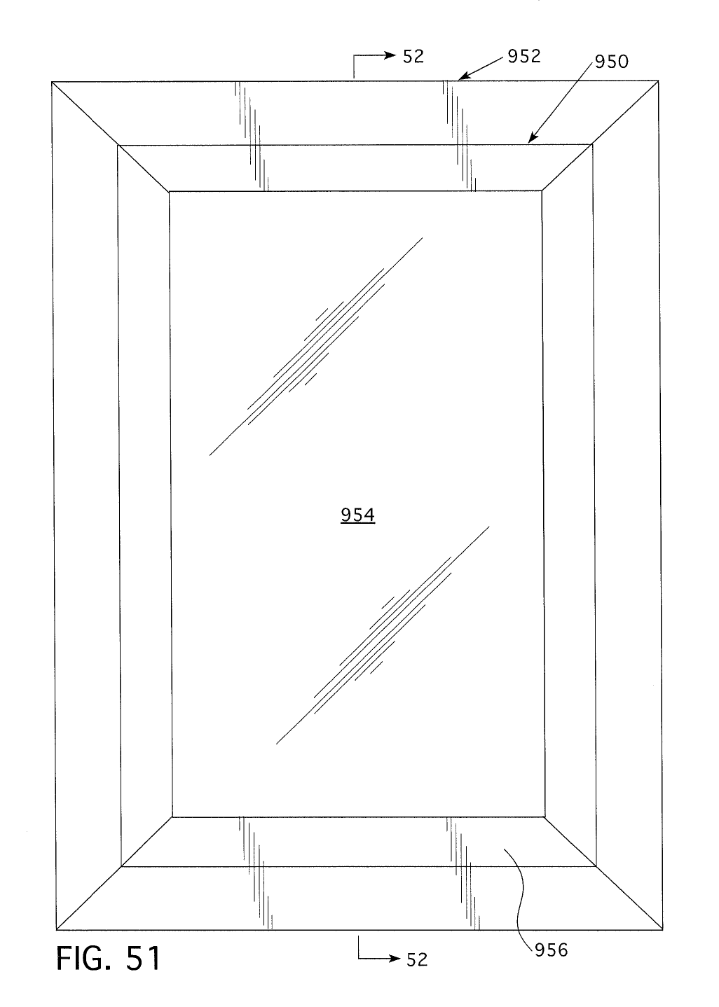

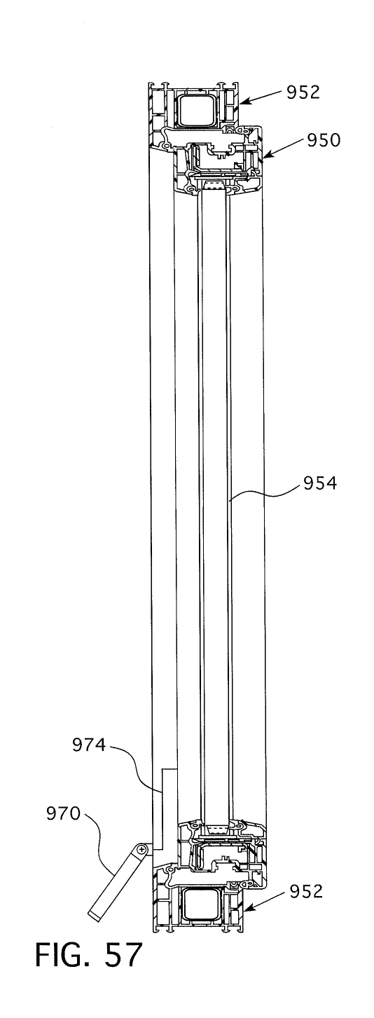

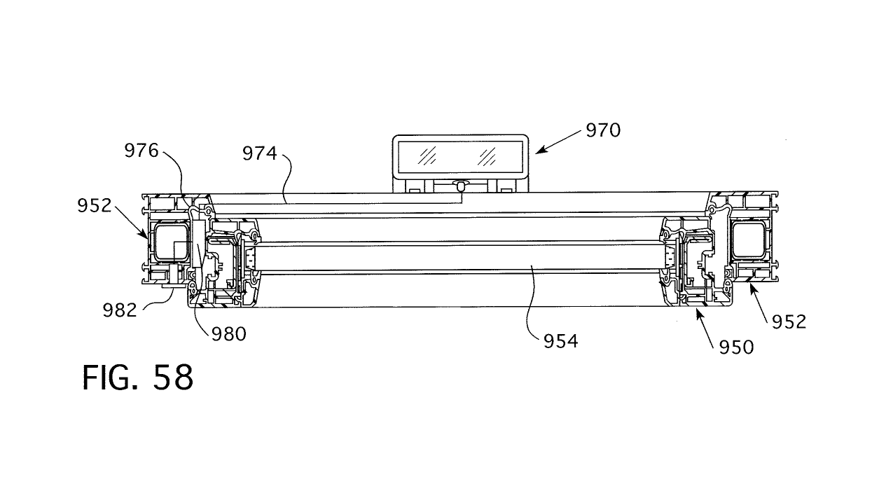

Referring to FIGS. 51-58, an additional embodiment of the invention will be considered. FIGS. 51-56 disclose a tilt and turn window which has a fixed frame and a moveable sash. In a first position, the window is closed. In a second position, the window is turned open as by rotation about a vertical axis, for example. In a third position which involves tilting with rotation about a horizontal axis, for example, establishing an opening of the desired angle with the opening facing generally upwardly for ventilation purposes. FIGS. 57 and 58 show a window of the type shown in FIGS. 51-56 provided with the solar collector, storage battery, USB port and associated wiring of the present invention. This embodiment provides for electrical energy obtained through the solar collector to be delivered to the battery for charging the same regardless of whether the window is in the closed, turned open or tilted position.

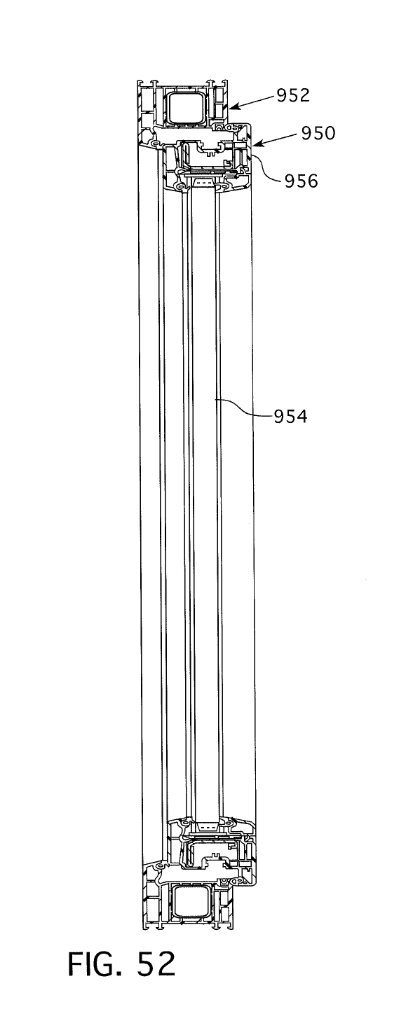

Referring to FIGS. 51 and 52, there is shown a sash 950 which is secured within window frame 952. The sash 950 has glazing 954 and sash frame 956. The tilt and turn window is shown in a first closed position. In the form illustrated, the two opening positions, i.e., turn open or tilt open, would result in rotational movement of the sash 950 toward the right as shown in FIG. 52.

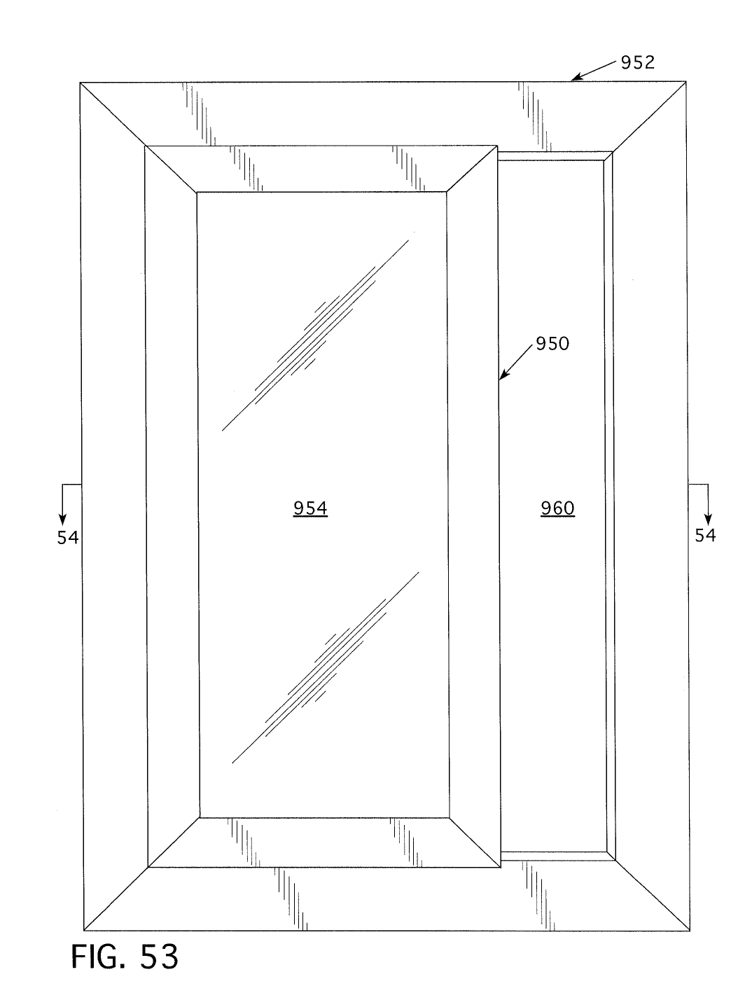

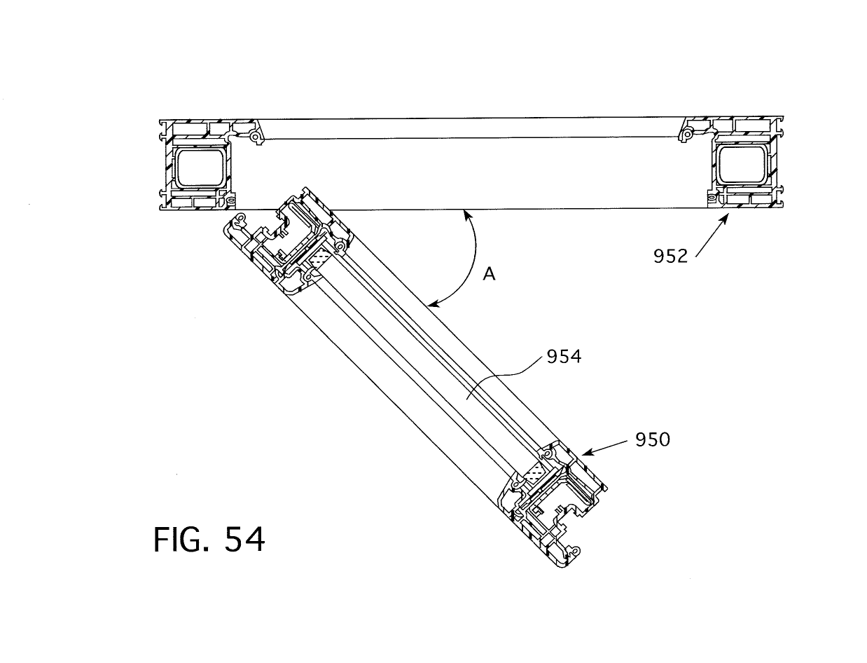

Referring to FIGS. 53 and 54, a second feature of the tilt and turn window is illustrated. In these figures, the window has been turned open by rotation about a vertical axis to establish the angle A between the sash 950 and window frame 952. This establishes opening 960. The hardware associated with grasping of the sash and the hinge and the like, will all be well known to those skilled in the art and, in the interest of simplicity and clarity of disclosure, have not been illustrated. In general, it will be preferred to have the sash 950 rotate toward the interior of the building. This approach not only facilitates attention to security issues, but also facilitates cleaning of the external surface of the window.

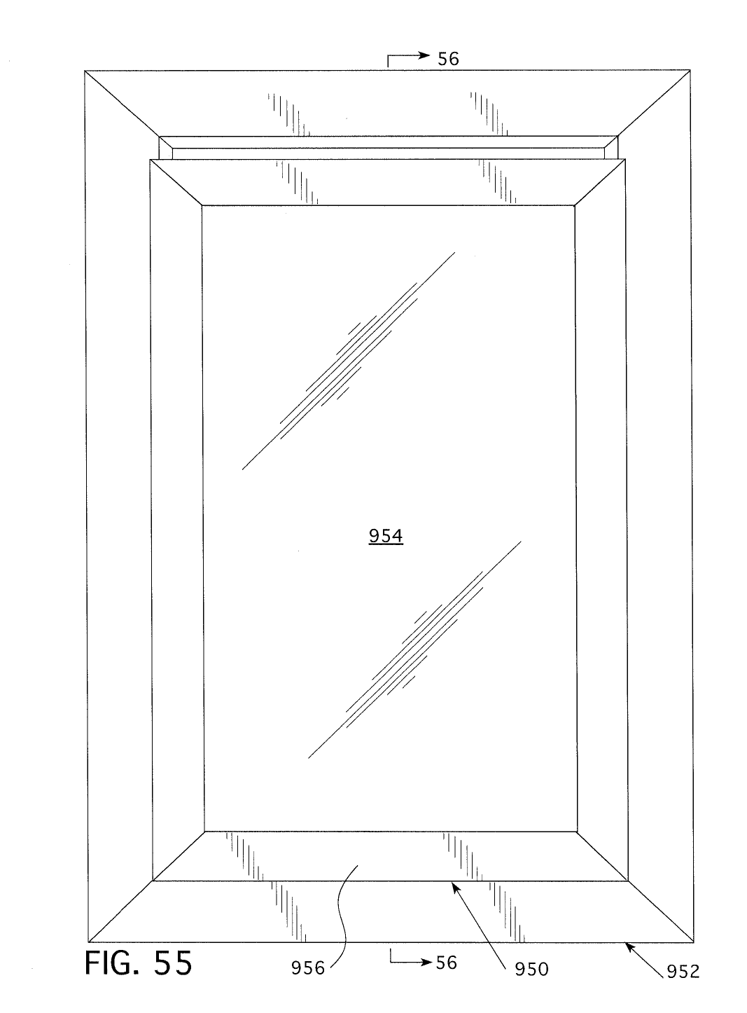

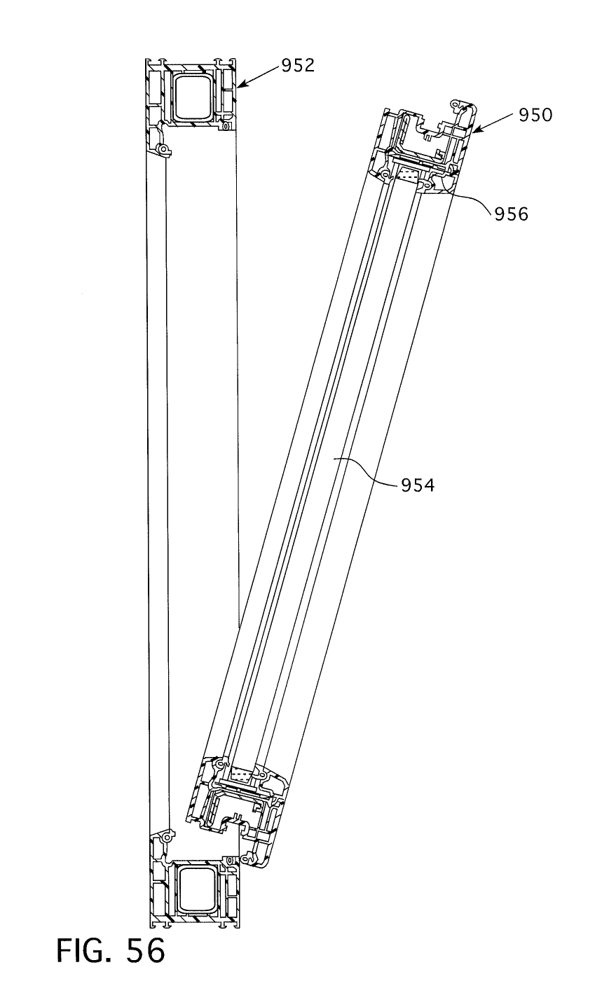

FIGS. 55 and 56 illustrate the third position involving the tilt function of the window. In this position, the sash 950 rotates about a lower portion to establish an opening which permits communication between the building exterior and interior for ventilation. In general, it will be preferred that in effecting the tilting action, the sash would be rotated toward the interior of the building.

Referring to FIGS. 57 and 58, there is shown in FIG. 57 a cross-sectional illustration similar to FIG. 52 with the window in the closed position, but with the solar collector battery, USB port and connecting electrical components shown. FIG. 58 is a horizontal cross-section showing the solar collector and associated components as applied to the tilt and turn window. The sash 950 and frame 952 are shown in closed position. The solar collector 970 which may, for example, be of the type disclosed hereinbefore, is secured to a portion of frame 952 which, in the form shown, is a lower portion of the frame, if desire, it could be secured to other portions of the frame 952. In the form shown, solar collector 970 extends angularly, outwardly and downwardly. A wire 974 is connected to the solar collector 970 and, as shown, in FIG. 58, extends into a portion 976 of the frame 952 and is connected to battery 980 for charging the same. The battery 980 is operatively associated with USB port 982 which faces the interior of the building in the form shown. It will be appreciated that the solar collector 970 is operatively associated through wire 974 with battery 980, which in turn, will be operatively associated with USB port 982 to facilitate charging whatever device it is desired to charge.

While the embodiment of FIGS. 51-58 have been disclosed with use in windows, it will be appreciated that it may be employed with doors as well.

As employed herein, the term “battery” will include the battery per se and also the electronics used to control power received over a wire from the solar collector and the power emerging from the battery and transmitted to the USB port or other charging devices.

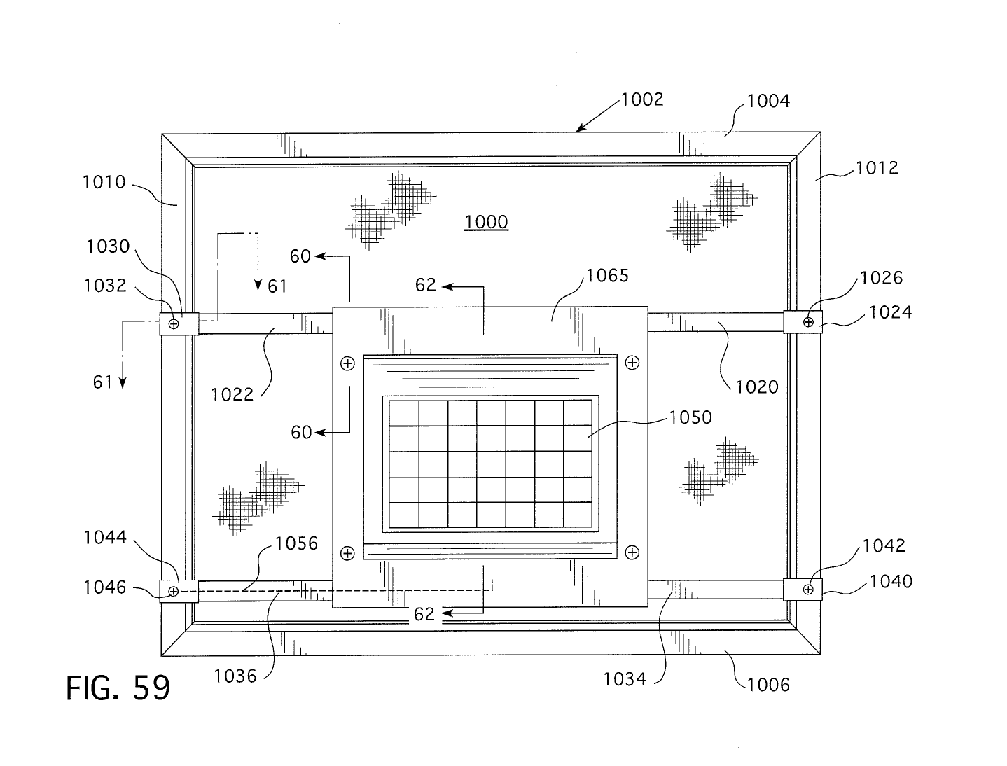

Referring to FIGS. 59-62, there is shown an apparatus which can be employed by a consumer to install a solar collector system of the present invention into a preexisting screen.

These figures show a window screen 1000 having a fixed rectangular frame 1002 having a pair of generally parallel upper and lower rails 1004, 1006 fixedly secured at their ends to frame members 1010, 1012 to establish a fixed rectangular frame for the screen 1000.

The retrofit solar construction has a pair of telescoping tubes 1020, 1022 which permit adjustment of the length such that the end of tube 1020 can be secured to framing member 1012 through clip 1024 employing screw 1026. Similarily, the end of tube 1022 when the relative length of the telescoping tubes 1020, 1022 has been established, may be secured to frame member 1010 through clip 1030 by means of screw 1032. The lower telescoping tubes 1034, 1036 are secured to frame 1010 by clip 1044 employing screw 1046 and to frame 1012 by clip 1040 employing screw 1042, respectively.

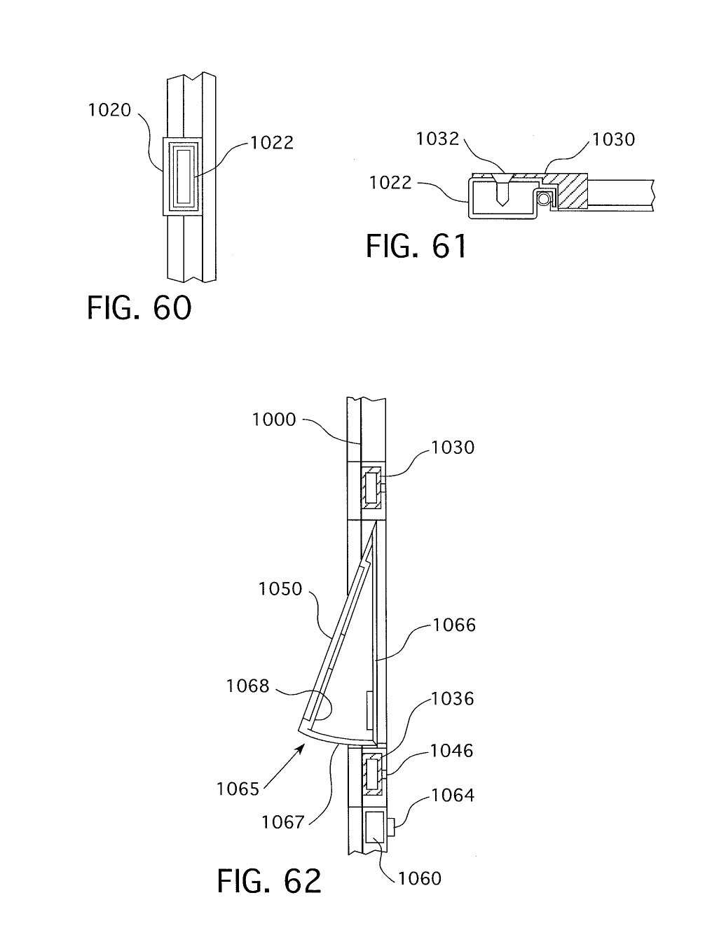

Referring to FIGS. 59 and 62, once the two sets of telescoping tubes 1020, 1022 and 1034, 1036 have been secured to the frame members 1010 and 1012, the solar collector 1050 will be secured to the two tube assemblies. This solar collector 1050 may be secured to the screen by means shown in FIGS. 30-41 or by other suitable means. An electrically conductive wire 1056 emerges from a lower portion of solar collector 1050 and passes through tube 1036 to the storage battery 1060 which in turn, is operatively associated with the power outlet 1064. In the form shown, the tubes 1020, 1022, 1034 and 1036 are of rectangular cross-sectional shape although other shapes may be employed. See FIGS. 60 and 61.

As shown in FIGS. 59 and 62, solar collector 1050 which is secured to a solar collector housing 1065 which is hollow and has a rear wall 1066, a bottom wall 1067 and an angularly disposed forwardly projecting front wall 1068 to which solar collection is secured 1050.

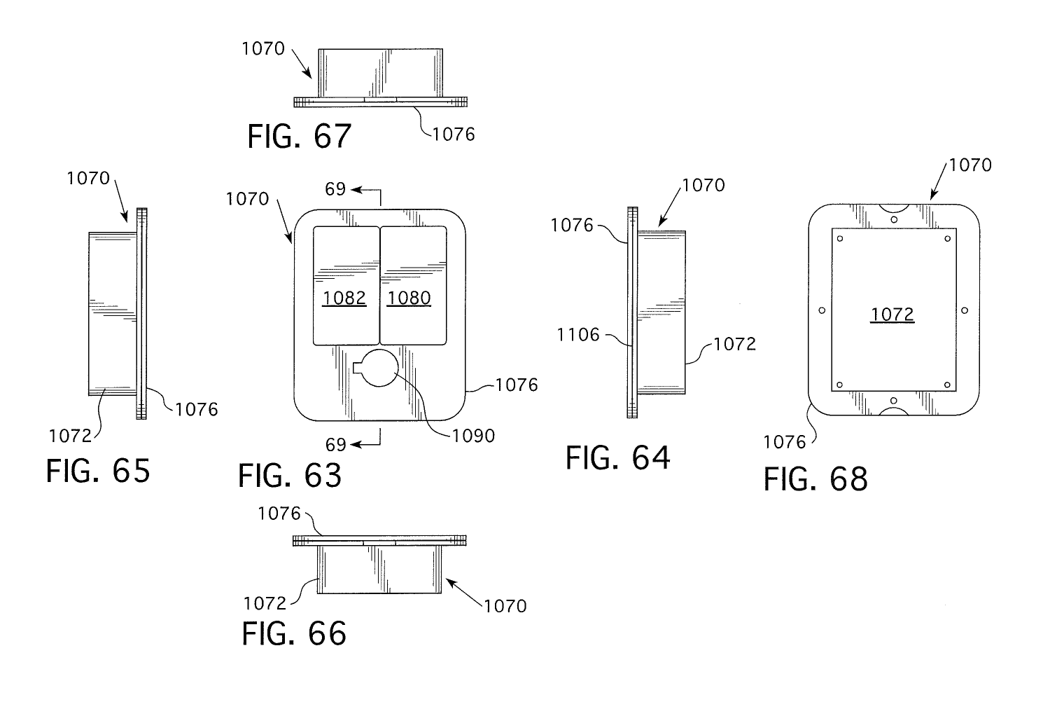

Referring to FIGS. 63-69, there is shown a solar energized system which is suitable for insertion in an exterior deck or stairway or other location where solar exposure combined with an electrical outlet and a recessed housing would be desirable.

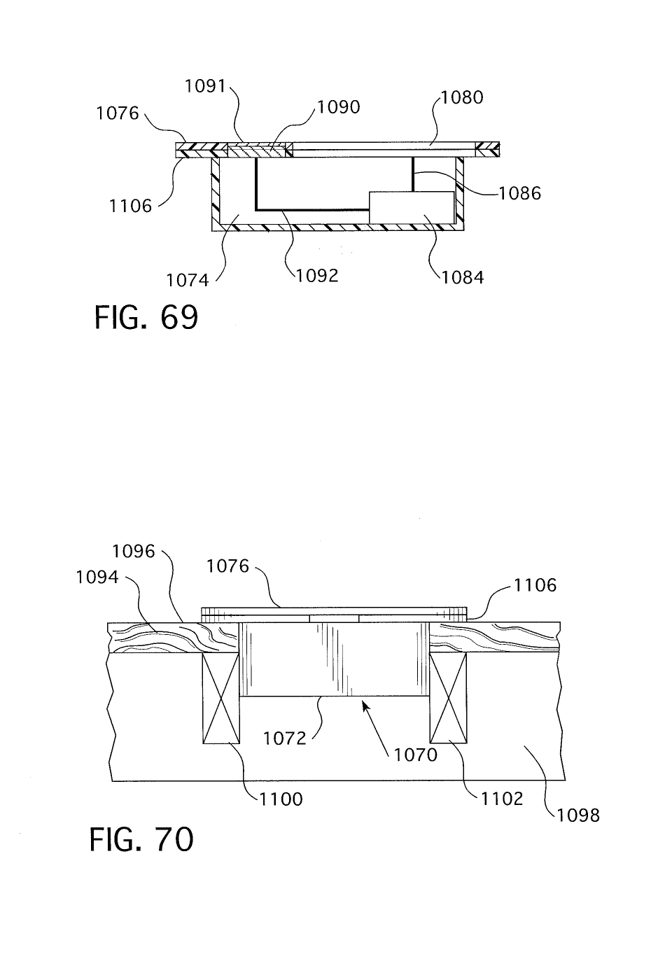

A mounting box 1070 has a base portion 1072 which defines an interior chamber 1074 and a cover 1076 within which is mounted solar panels 1080, 1082 which, referring to FIGS. 69 and 70, is electrically connected to storage battery 1084 by wire 1086. Preferably, a translucent protective cover 1076 will be secured over cover 1106. Storage battery 1084 is electrically connected to covered USB outlet 1090 by wire 1092. The electrical outlet 1090 preferably has a cover 1091 to protect the outlet from the elements. The cover 1091 is structured to be either rotatable or removable in order to provide access to the underlying power outlet 1090.

In the example shown in FIG. 70, the box 1070 is mounted within an opening in wooden deck 1094 with the upper surface 1076 generally flush with the upper surface 1096 of the wooden deck. The solar collector may be secured to the box 1070 by any suitable means. The deck 1094, which in the form shown is wood, has an upper surface 1096. The box 1070 is shown supported by floor joist 1098 and crossmember supports 100, 1102.

Overlying the solar panels 1080, 1082 is a protective transparent or translucent panel 1076 which protects the solar panels 1080, 1082 from undesired physical contact.

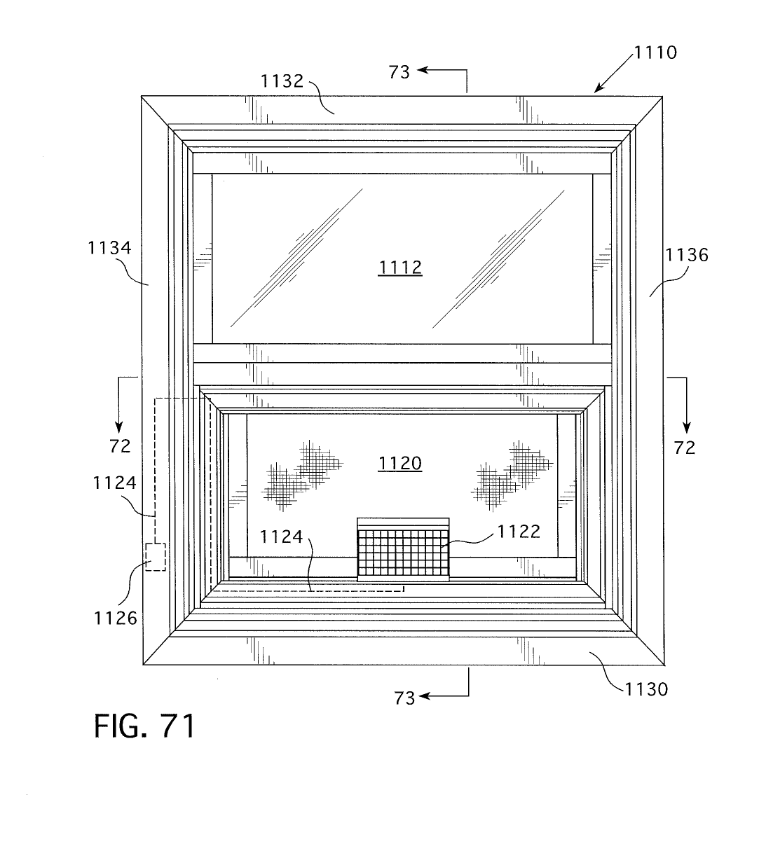

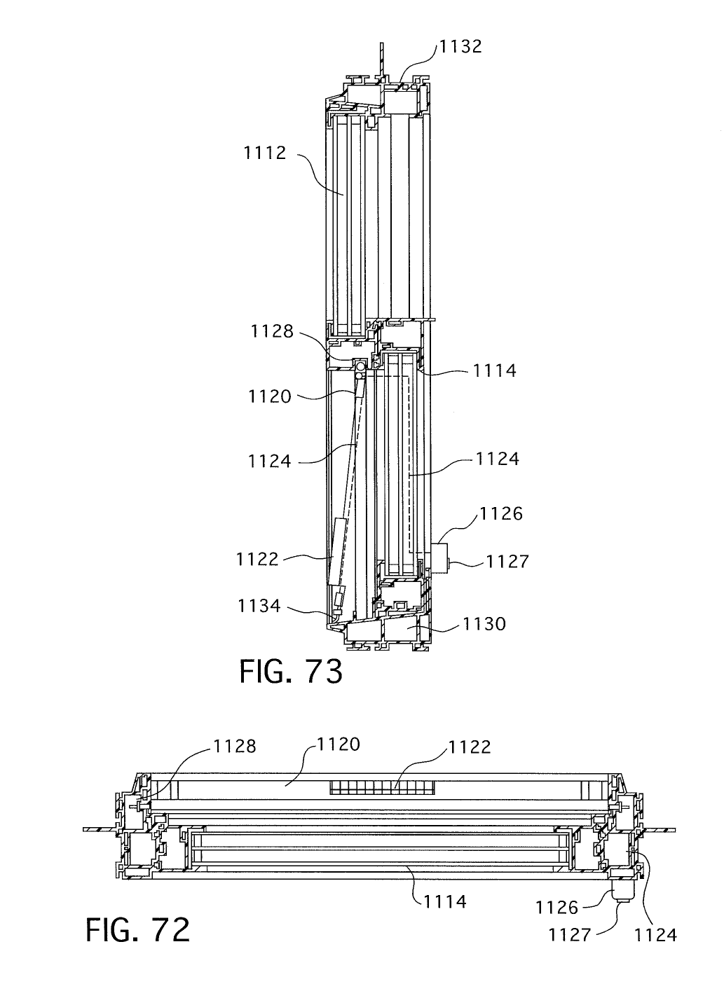

Referring to FIGS. 71 through 73, there is shown a single hung window having a pivoting screen to which is secured a solar collector

More specifically to FIGS. 71 through 73, there is shown a single hung window 1110 having a fixed multi-pane upper glazing 1112 and a multiple pane vertically movable sash 1114. The window may have a flap seal 1134 on the bottom and weather stripping on the sides. Positioned in front of the sash 1114 is a rotatable screen 1120 which rotates about a pivot pin 1128 which is mounted toward the upper end of the screen 1120, thereby, permitting the lower end of the screen 1120 to rotate outwardly. A solar collector 1122 is secured within the screen. The lower end of the screen 1120 has a flap seal 1134 to resist entry of foreign material around the lower edge of the screen. Compression of the flap seal 1134 assists with holding the screen in place. The flap seal 1134 rests on the bottom rail of sill 1130. The flap seal 1134 also serves to resist entry of insects and foreign matter when the screen 1120 is rotated outwardly. A wire 1124 is operatively associated with solar collector 1122 and, in the form shown, moves upwardly and rearwardly to the exterior of the frame for connection to the storage battery 1126 which is combined with a power outlet 1127.

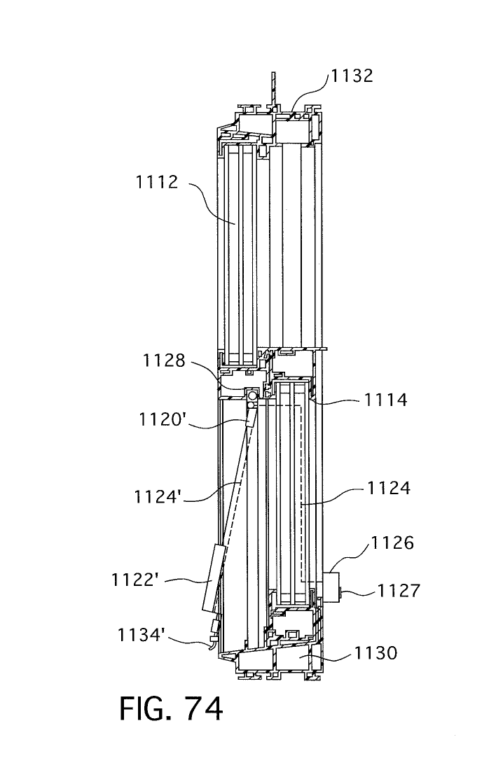

FIG. 74 shows the screen rotated farther outwardly than in FIG. 73 with the reference numbers 1120′, 1122′, 1124′ and 1134′ corresponding to the as primed numbers of FIG. 73. It will be appreciated that the single-hung window 1110 has sill 1130 and upper rail members 1132 cooperating with framing members 1134, 1136 to define the single-hung window, while permitting access to the screen when the sash 1114 is moved to its upper position so as to establish the desired angle of the screen 1120.

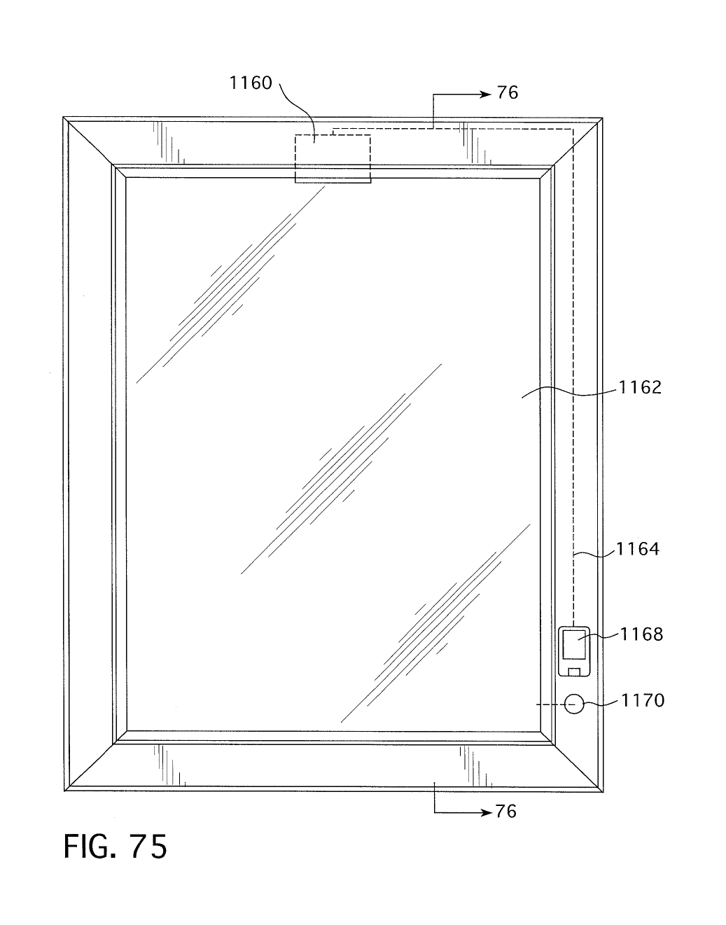

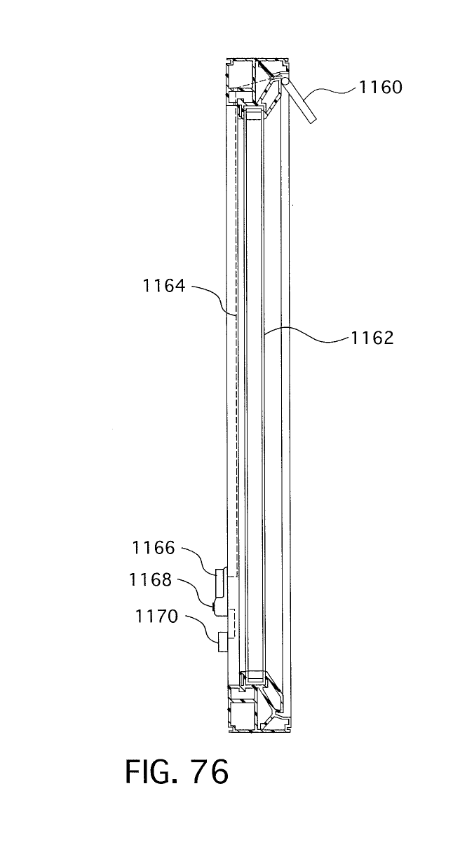

Referring to FIGS. 75 and 76, there is shown a fixed, generally rectangular frame member 1 which has a framed switchable glazing unit 1162 secured therewithin. The glazing unit 1162 can be turned opaque (preferably over 100 percent of the glazing unit area) in order to block solar gain by means of an electric current which passes through the glass. An electrically conductive wire 1164 connects the solar collector 1160 to the storage battery 1166 which is operatively associated with a USB outlet 1170 or another type of power outlet which is operatively associated with the battery 1166.

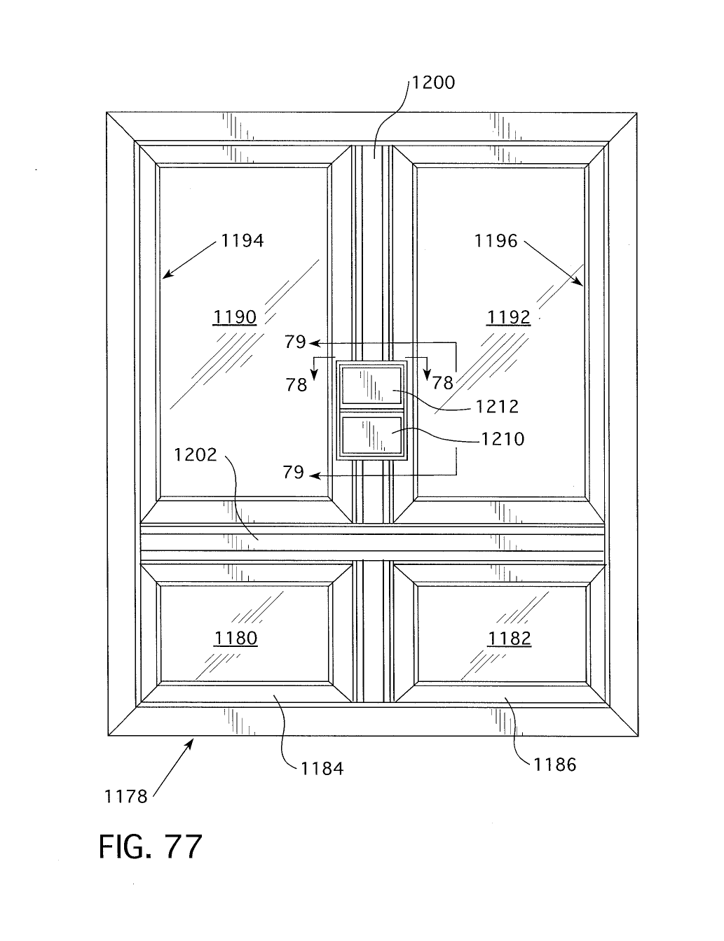

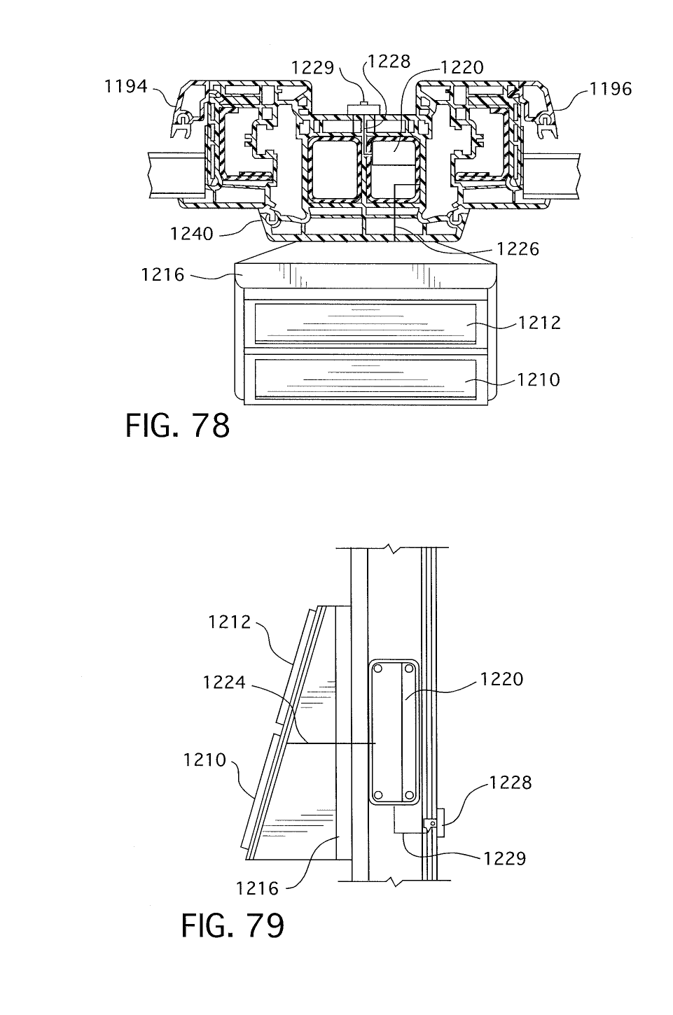

Referring to FIGS. 77 through 79, there is shown a window wall structure 1178 having a pair of lower panels 1180, 1182, which may be glazed, secured respectively within appropriate frames 1184, 1186. A pair of upper panels 1190, 1192 is fixedly secured within frame members 1194, 1196. A mullion 1200 is disposed between frames 1194, 1196. In the form shown, a rearwardly open a notch (not shown) is provided in the rear surface of framing member 1202 to permit mullion 1200 to pass therethrough. A pair of solar collector panels 1210, 1212 are as shown in FIGS. 78 and 79, projecting angularly outwardly from support 1216 and face the exterior of the building or other structure. A storage battery unit 1220 is electrically connected to the solar panels 1210, 1212 through electrical wire 1226. The USB electrical outlet 1228 is connected to the storage battery 1220 through electrical wire 1229.

As shown in FIG. 78, the storage battery 1220 and USB port 1226 are received within a recess in mullion 1240.

It will be appreciated that in this manner, the window wall with its fixed panels 1180, 1182, 1190, 1192 provides for effective exposure of the solar panels 1210, 1212 to the exterior of the building while effectively securing the operatively associated storage battery 1220 and USB port 1226.

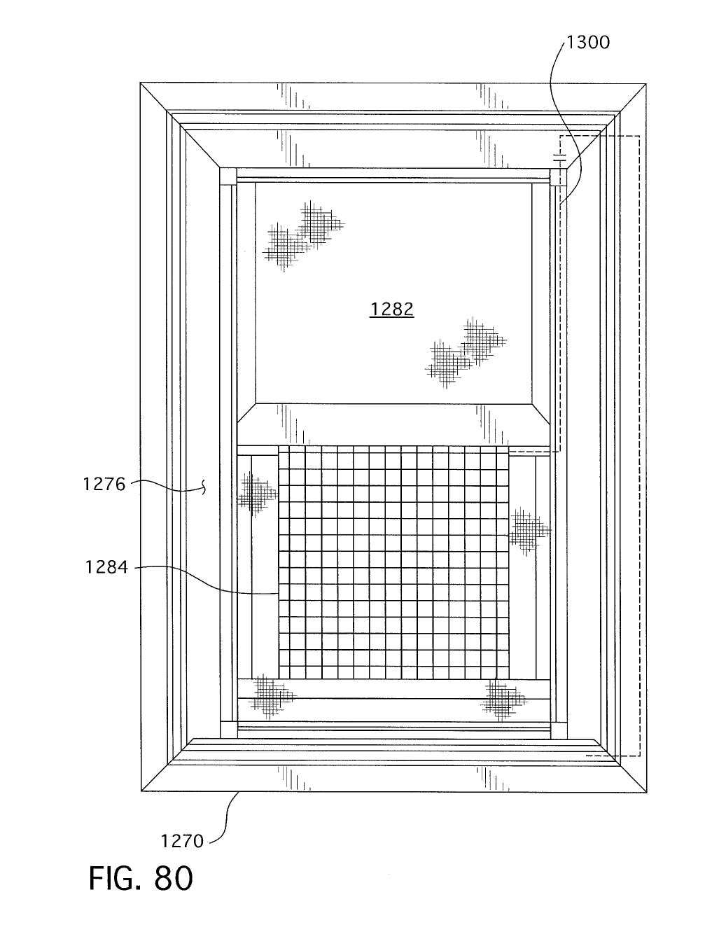

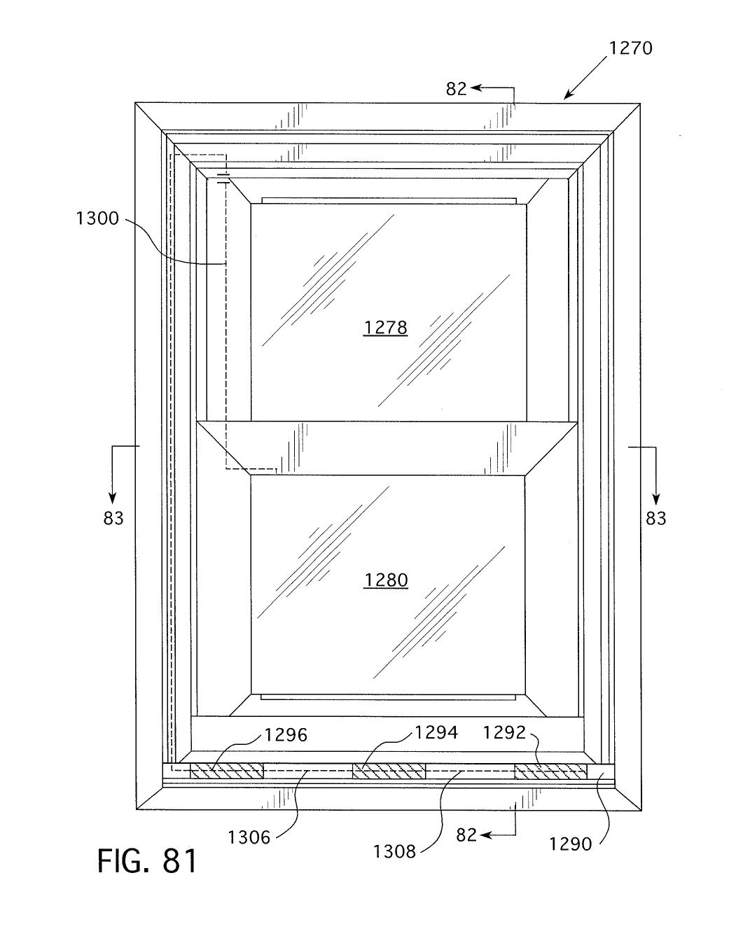

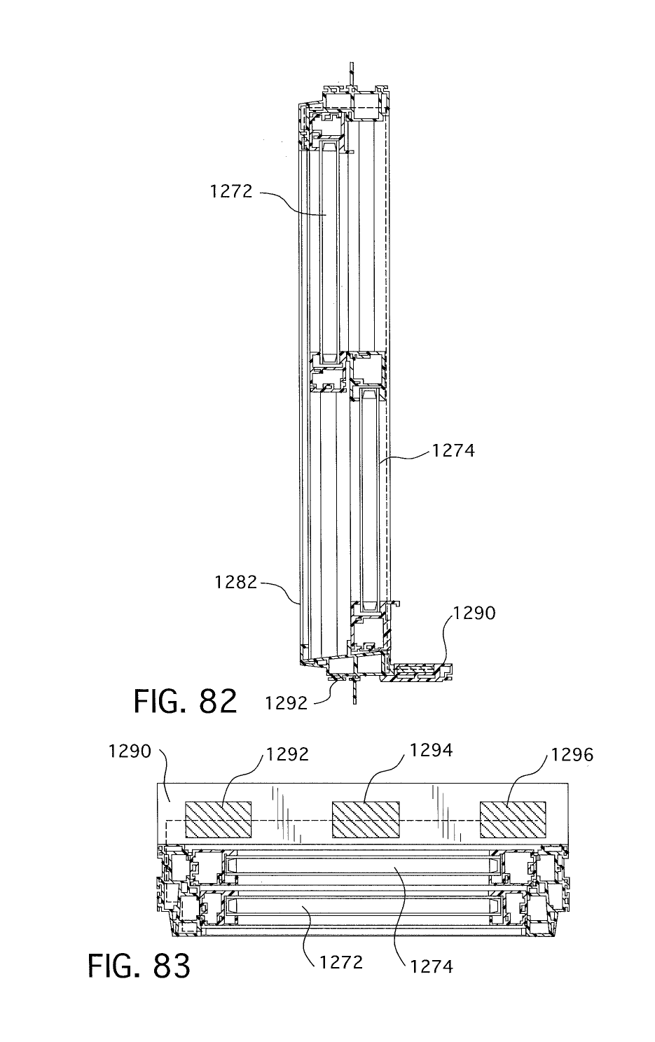

There is shown in FIGS. 80-83 a double hung window 1270 having an upper double paned sash 1272 and a lower double paned sash 1274 (FIG. 82) secured within a rigid generally rectangular frame 1276. An upper glazing pane 1278 overlies a lower glazing pane 1280 with a rigid wire mesh screen 1282 disposed and substantially completely covering panes 1278 and 1280. A solar collector 1284 covers about a 30 to 90 percent of the area of lower pane 1280. The solar collector 1284 is secured to the screen 1282 by any suitable means. In the form shown, the double hung window 1270 has a projecting ledge 1290 which projects inwardly from the window sill 1292 as best shown in FIGS. 82 and 83. The ledge is provided with three relatively spaced proximity charges 1292, 1294, 1296 Electrical wire 1300 is connected to the solar collector 1284 and extends initially upwardly and then downwardly within the window frame so as to reach the first proximity charger 1296 which is, in turn, electrically connected to proximity charger 1294 through wire 1306. Wire 1308 connects proximity charger 1294 to proximity charger 1292.

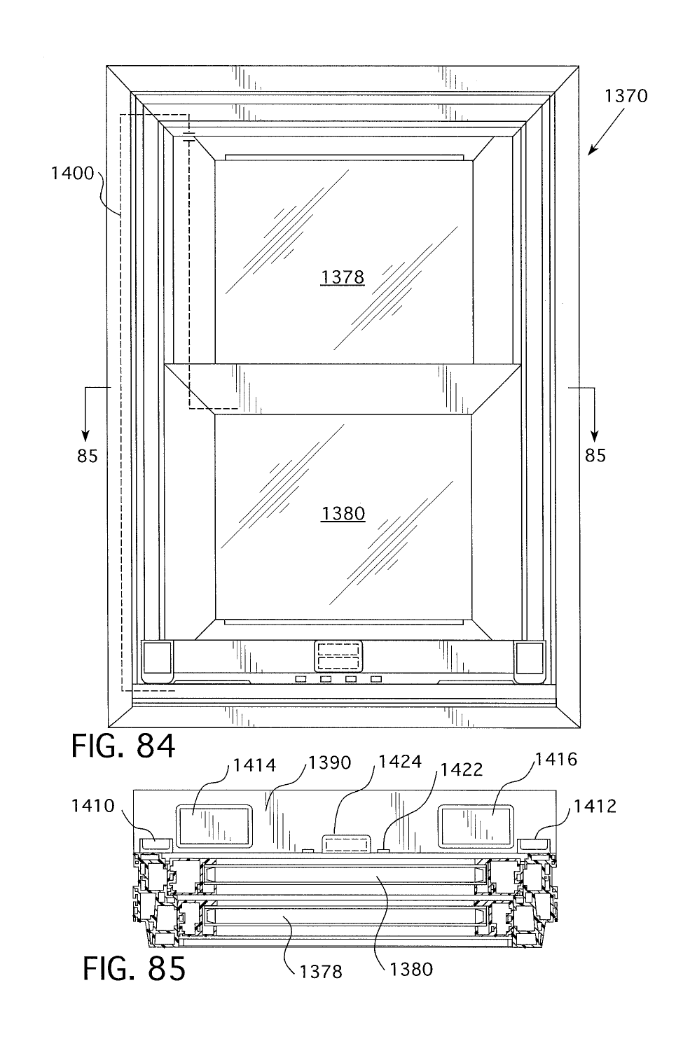

Referring to FIGS. 84 and 85, this represents a potential net zero energy charging station employed with the window of the type shown in FIG. 80 with certain modifications. The double hung window 1370 has a double-paned upper window 1378 and a double-paned lower window 1380. A wire 1400 extends from the solar collector such as shown as element 1284 in FIG. 80, extends downwardly to ledge 1390. In this embodiment, rather than having the proximity chargers, the ledge 1390 has a pair of portable device battery chargers 1410, 1412, disposed at opposite ends of the ledge 1390 and a pair of charging pads 1414 and 1416 disposed adjacent the portable device battery chargers 1410, 1420. A USB port 1422 is also provided on the ledge 1390 as is a battery charger 1424. Devices 1410, 1412, 1414 and 1416 are all energized by the solar collector through wire 1400

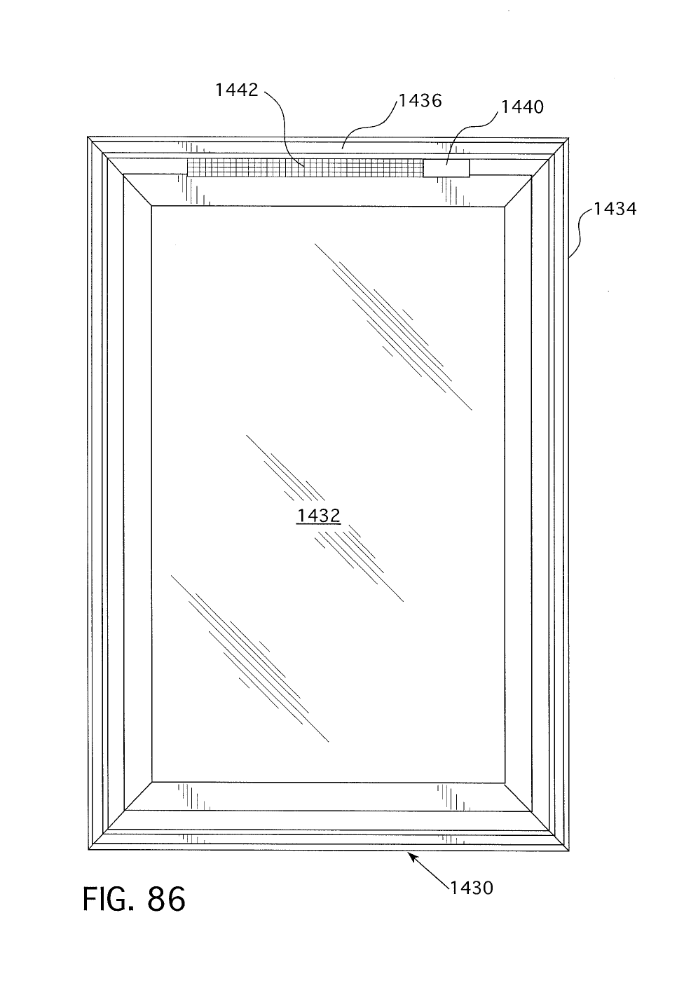

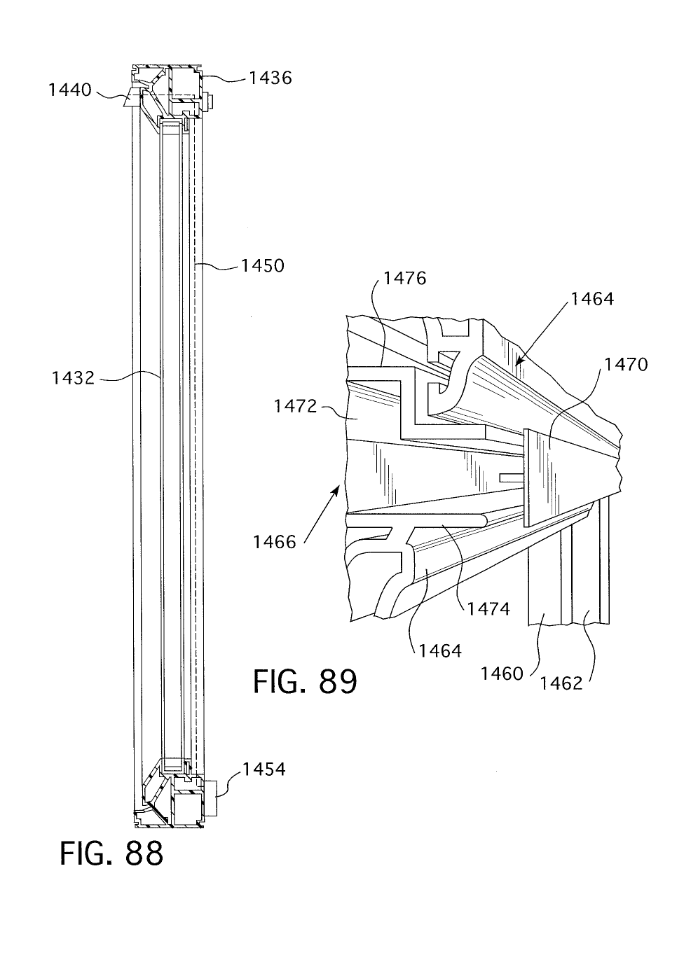

Referring to FIGS. 86 through 88, there is shown an embodiment having a trickle ventilator hood combined with a solar collector panel A fixed pane window 1430 having a double paned glazing panel 1432 and a generally rectangular frame 1434 is shown in these figures. As shown in FIGS. 86 and 88, the upper rail 1436 of the frame 1434 has an elongated solar collector panel 1440 which projects outwardly and downwardly. The solar collector panel 1440 cooperates with the window rail 1436 to define an opening which receives a ventilator 1442 which permits limited passage of air therethrough. The ventilator 1442 has an exteriorly exposed grill, which resists entry of insects and foreign matter into the window. The ventilator 1442 may have a screen (not shown) secured to the interior thereof.

FIG. 89 shows a form of window mounted is ventilator which is suitable for use in combination with the solar collection system of the present invention. A window 1460 has a frame 1462 with a header 1464. Overlying the frame member 1464 is ventilator 1466. The ventilator 1466 allows fresh air to enter the building. It has a front panel 1470 which in the form shown defines an opening with the header 1464. A passageway 1472 is defined by the base 1474 and upper member 1476.

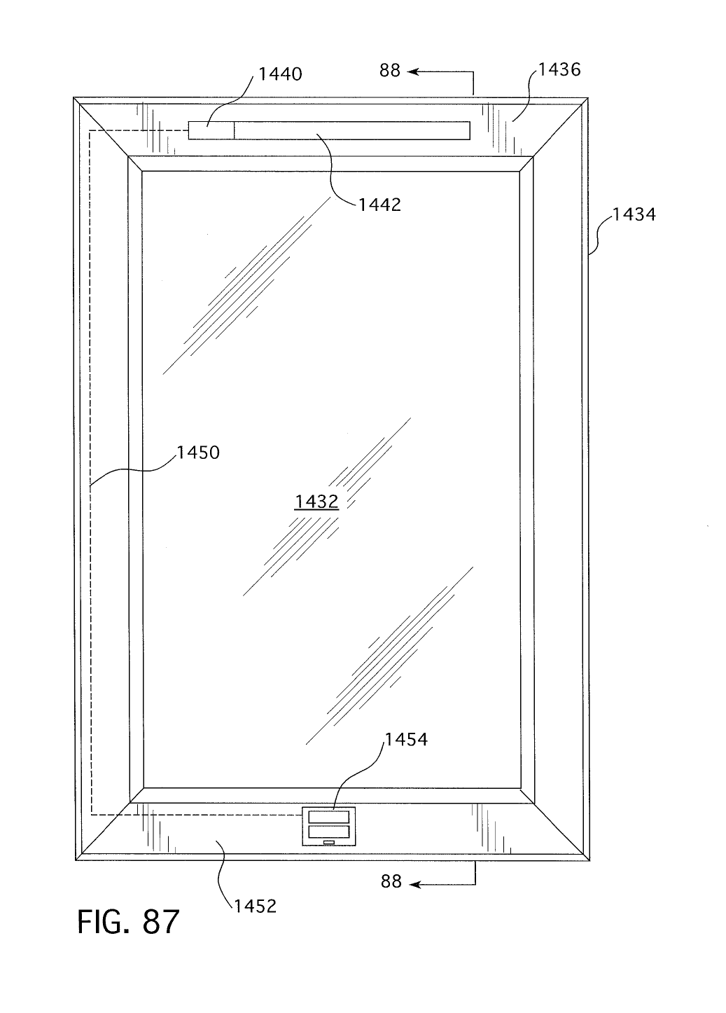

An electrical wire 1450 as shown in FIG. 87 is connected to the solar collector 1440 and extends downwardly to the sill 1452. The wire 1450 is connected to a storage battery and power outlet 1454 which may be accessed from the building interior.

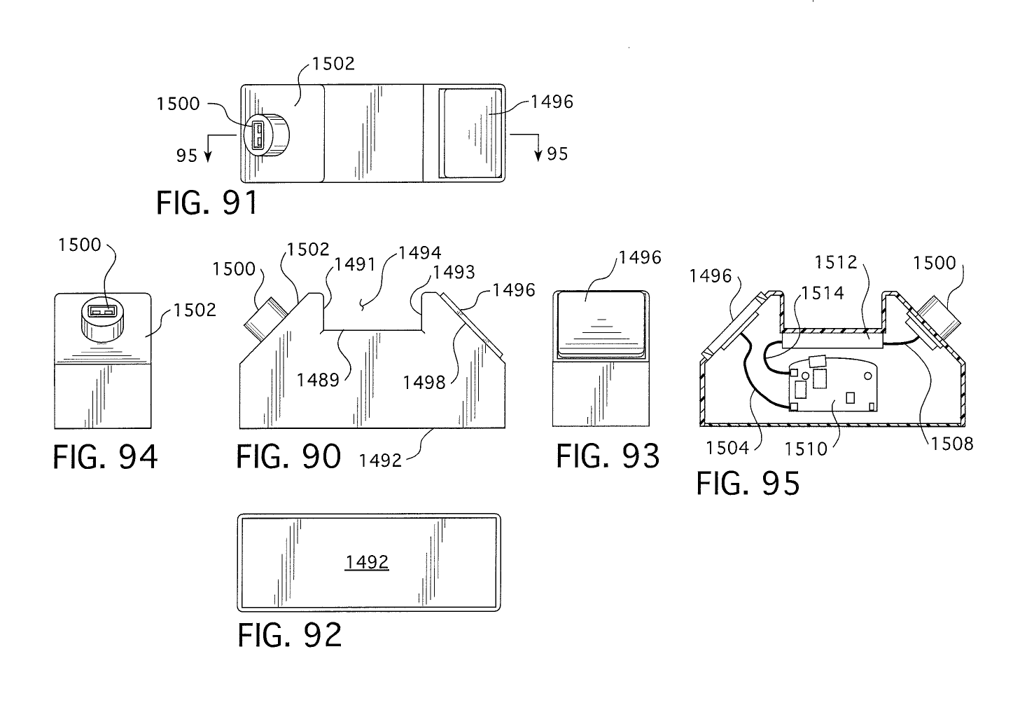

FIGS. 90 through 95 show a solar collector of the present invention of the type employable as a railing foot support. Referring to FIG. 90, there is shown a railing support foot having a base 1492 which is substantially planar and adapted to be in surface to surface contact with the underlying support for the railing support foot. The railing support foot defines an upwardly open recess 1494 for receipt of the railing. Referring to FIGS. 90 through 95, it will be noted that a solar collector 1496 is secured to an angularly positioned wall 1498 of the foot. A waterproof USB outlet 1500 is secured to an angularly oriented foot wall 1502. Generally, horizontal wall 1489 cooperates with a pair of generally vertical walls 1491, 1493 to define upwardly open recess 1494.

FIG. 95 shows a cross-sectional elevational view through 95-95 to show the electrical wire 1504 connecting the solar collector 1496 with circuit board 1510 which has wire 1514 connecting it with storage battery 1520 and Wire 1508 connects the storage battery 1512 with the waterproof USB outlet 1500.

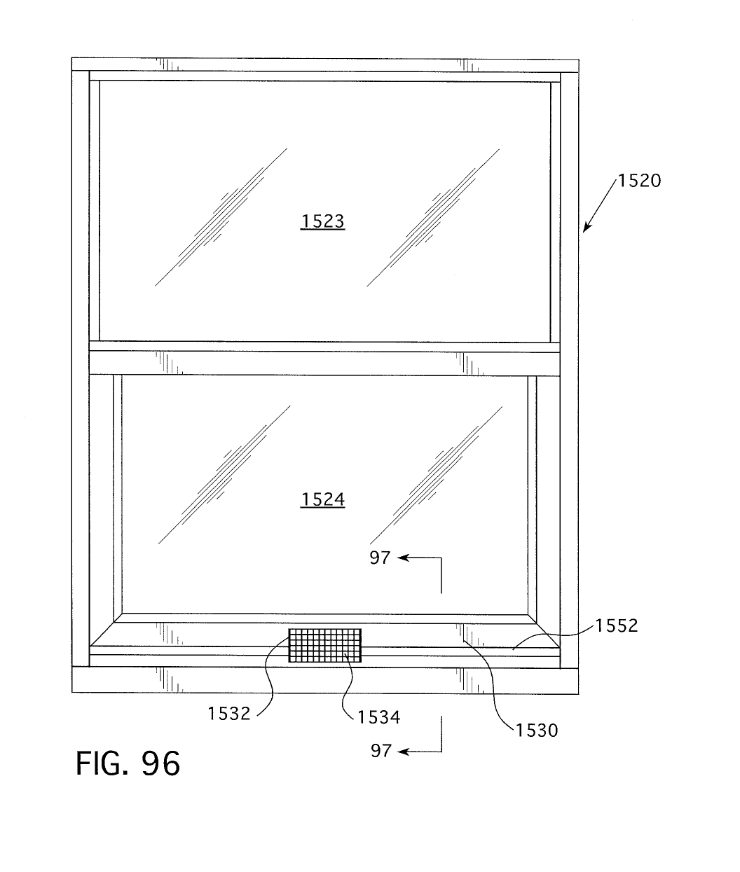

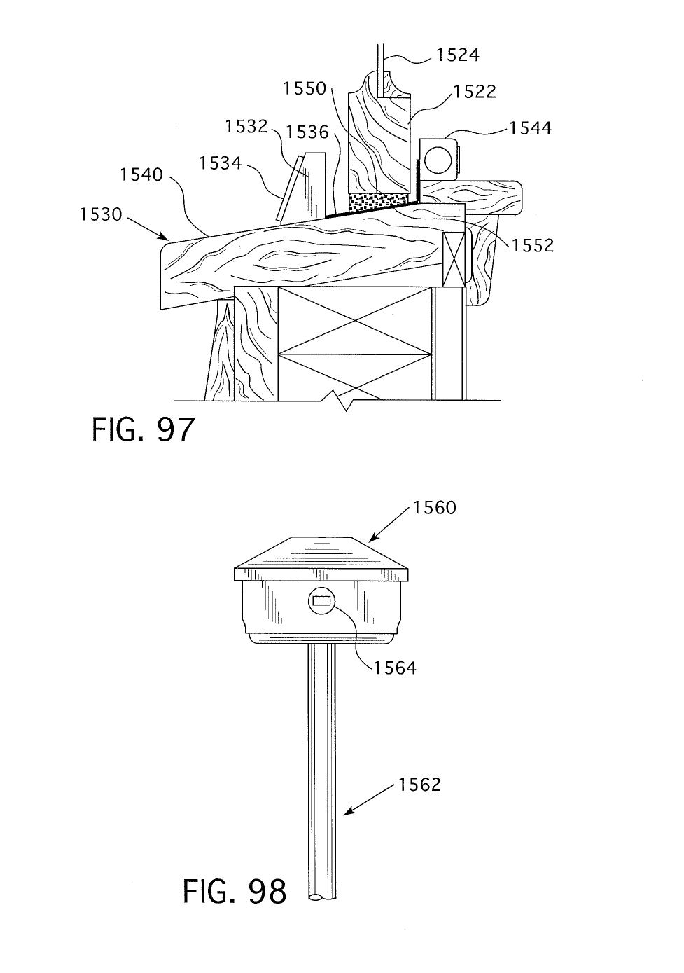

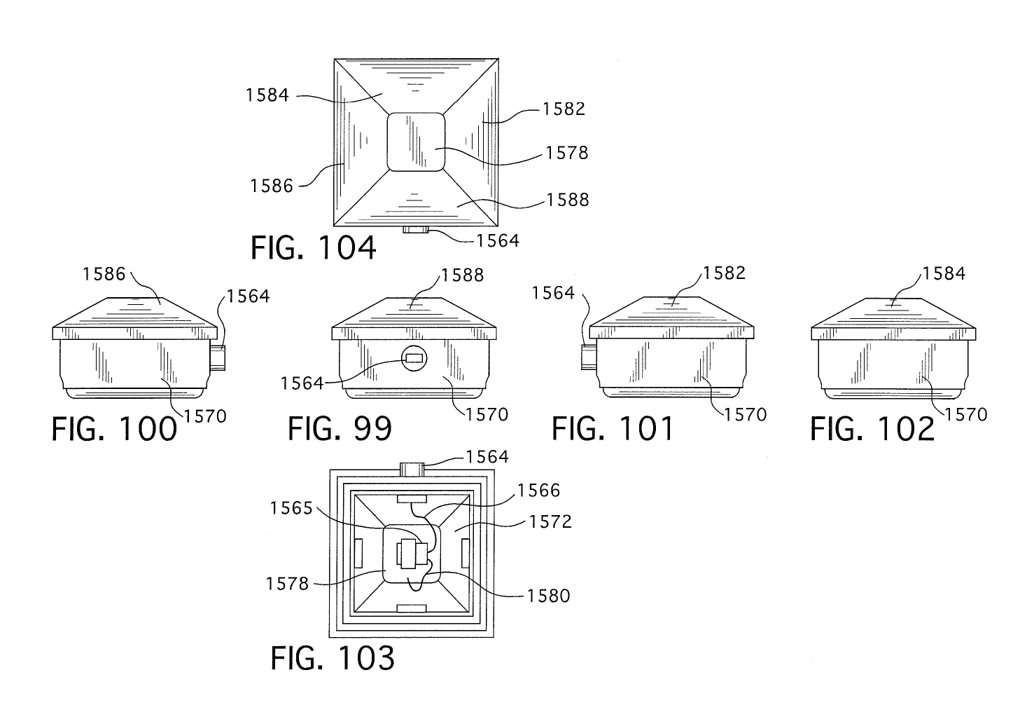

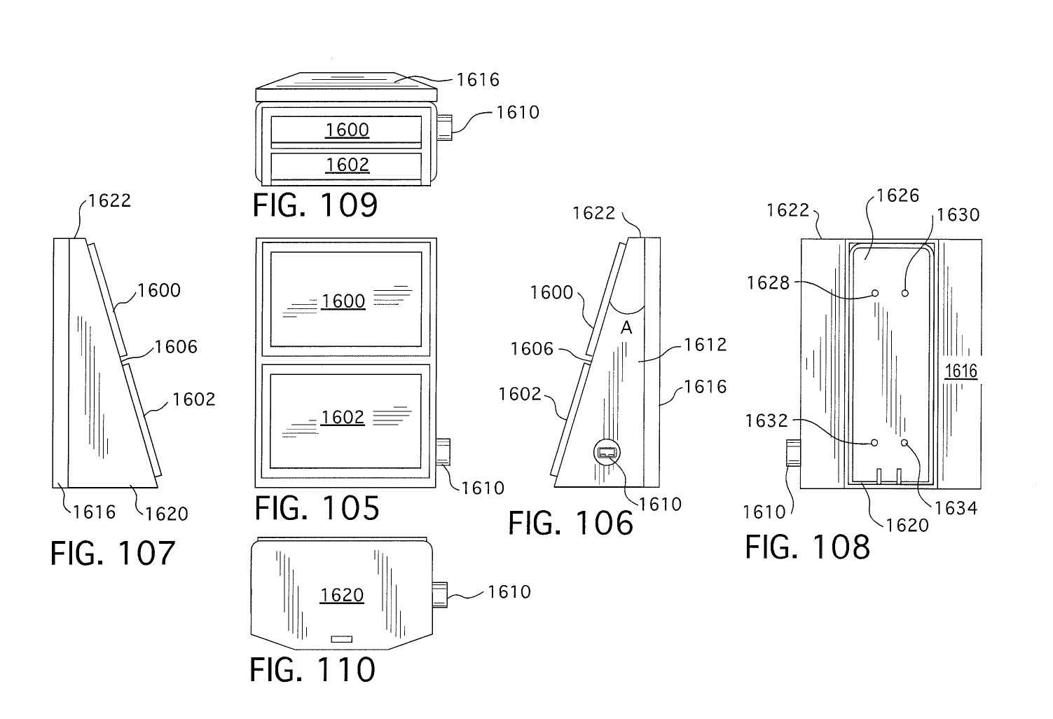

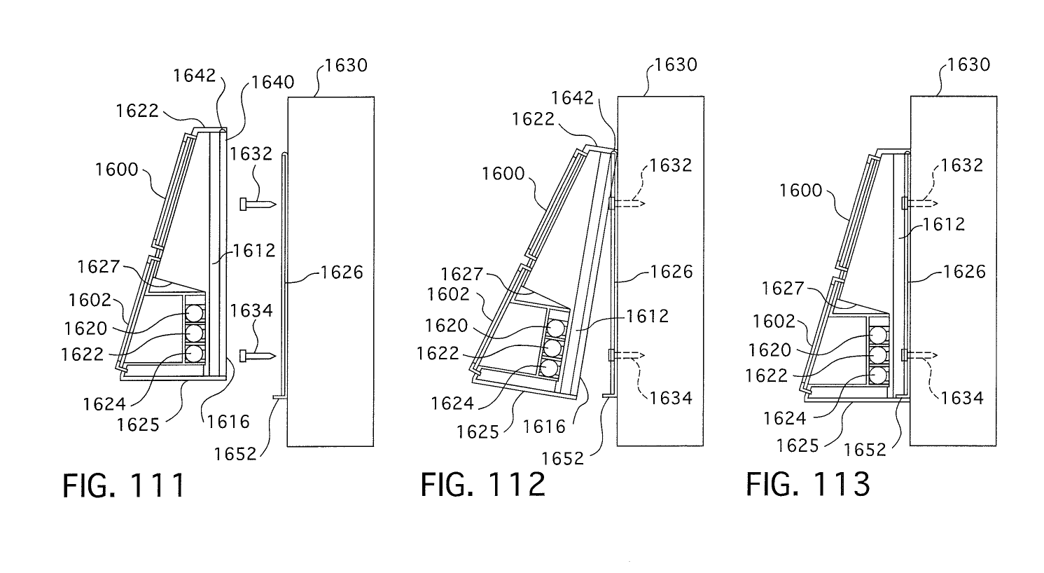

Referring to FIGS. 96 and 97, there is shown an embodiment of the invention which facilitates installation of an exteriorly positioned solar collector in combination with a wooden sill and an interiorly positioned storage battery and power outlet combination. The window 1520 has a wooden frame 1522, upper glazing 1523 and lower glazing 1524. There is shown a window sill 1530 with a solar collector housing 1532 to which is secured a solar collector 1534. An electrical wire 1536 extends along the upper surface 1540 of the window sill 1530 under the lower sash frame 1522 and is secured to the storage battery/power outlet combination 1544. The lower surface 1550 of the lower window frame 1522 has secured to it a compressible weatherstrip foam layer 1552 which is substantially continuous in both width and length with the lower sash frame 1522. The weather strip foam layer 1552 may have a pressure sensitive adhesive secured thereto such that it may be secured directly to the lower surface 1550 of the lower window frame 1522. It will be appreciated that in this fashion, the window when lowered, will not damage wire 1536, yet will provide an effective seal against weather, against air and foreign matter entering the building.

Referring to FIG. 98 through 103, there is shown a solar post cap 1560 which is supported by a post 1562 which has its lower end (not shown) secured within soil, concrete or other suitable support material. As shown in FIG. 103, a weatherproof USB 1564 or other electrical outlet is operatively associated through wire 1566, with battery 1565. It will be appreciated that in this manner, an esthetically pleasing solar cap suitably supported by a post, will provide ready access to a power outlet in an area which may be remote from a building.

The solar post cap 1560 has, as shown in FIGS. 98 through 103 has an externally accessible waterproof USB 1564 which is energized by battery assembly 1565 through wire 1566 which is operatively associated with the solar collector 1578 through wire 1580. The weatherproof USB 1564 projects through lateral surface 1570. The upper surface of the cap consists of four trapezoid shaped panels 1582, 1584, 1586, 1588 which are in intimate edge to edge contact and have their uppermost edge in secured relationship with respect to solar panel 1578. In this embodiment, it will be appreciated that the solar panel 1578 will provide a source of energy to energize the battery 1565 which is operatively associated with both the solar panel 1578 and the waterproof USB thereby providing a replenishable source of energy without requiring that the cap be directly wired to a building structure or other source of energy.

If desired, the solar post cap 1560 could have a light (such as an incandescent bulb or LED array, for example) secured thereto which is energized by the disclosed solar collector 1578 and battery 1565 in addition to or in lieu of having the USB 1564.

Referring to FIGS. 105 through 110, there is shown there is shown a pair of solar panels 1600, 1602 which are secured to angularly disposed support panel 1606 which has an angle A (FIG. 106) with respective rear panel 1616. Angle A is preferably about 20 to 40 degrees. A weatherproof USB port 1610 projects outwardly from sidewall 1612 and is energized by a battery or group of batteries (not shown in this figure) disposed within the housing. The housing has an upper wall 1622 and a base 1620. A mounting bracket 1626 is secured to the rear wall 1616 and has a plurality of opening 1628, 1630, 1632, 1634 through which mechanical fasteners may pass in order to mount the structure of the housing on a suitable support.

This embodiment may also be provided with a light source energized by the battery, if desired. The mounting bracket 1626 is a separate piece which is structured to be snap fit into the rear of the housing. In one version, screws may pass through openings 1628, 1630, 1632, 1634 and into a supporting structure after which the mounting bracket 1626 may be snap fit to the housing.

In an alternate approach, the mounting bracket 1626 may be secured to the housing and the openings may be passed over screw heads secured to the wall or other support structures. Referring to the cross-sectional illustrations shown in FIGS. 111 through 113, the manner in which the housing may be secured to a support structure will be discussed. As shown in these figures, a plurality of batteries 1620, 1622, 1624 are operatively associated with solar collectors 1600, 1602 by wire 1627 with the batteries operatively associated with the USB port 1610 by a wire (not shown). In this mode of securing the housing to a support structure 1630, four mounting screws such as 1632, 1634 for example, are secured to support at positions corresponding to openings 1628, 1630, 1632, 1634 (FIG. 108). The screw heads are then passed through openings 1628, 1630, 1632 and 16234 in order to serve to secure mounting bracket 1626 to the support 1630.

It will be appreciated that for many installations, it will be preferred to have the solar collector rigid or substantially rigid. In some instances it will be preferred to have the solar collector flexible so as to conform to the profile of an adjacent structure, for example.

It will be appreciated, therefore, that the present invention provides unique constructions facilitating the energy efficient charging of storage batteries which in turn are structured to energize various devices through power outlets, such as USB power outlets, disposed interiorly of the building. The connections between the solar collector and the battery being charged are preferably through wires which pass through hollow structural portions of the window and door framing, and are so structured as to not interfere with normal functioning of the windows and doors, particularly with references to those which have moving sashes. In the alternative, a window or door frame and sash can complete a circuit or a screen and frame can complete a circuit. A window or door frame may be in a first position with the contacts touching to complete the circuit and break the circuit when the window or door is in a second position. Such a construction may be employed in casement windows as well as other types of windows and doors with one contact electrically connected to the solar collector and the other contact electrically connected to the storage battery such as, for example tilt and turn windows. The circuit can also be completed by rotating sashes and electrical contacts positioned appropriately. The systems are designed to be employed with factory manufactured products, retrofit products and field adjustments.

If desired, the component parts such as the solar collectors, batteries, USB ports and other electrical components, for example, may be provided with quick connect features to facilitate rapid replacement of parts. If desired, the USB ports may be retractable.

The windows and doors of the present invention also permit positioning of the solar collectors and portions of the system in a wide variety of locations. The solar collectors depending upon design preference, may be secured to the glass, a frame, a sash or a screen, for example. They may also be secured, for example, to fresh air ventilators. In certain embodiments, the solar collector would be secured to screens rather than directly to portions of the windows. In other embodiments, the storage battery being charged may be positioned inside the window or door for direct interior access to the power outlets, or closely adjacent to the solar collector with appropriate electrical connection from the storage battery to the power outlets. The system may be employed with a wide variety of residential and commercial windows and doors of the fixed or movable sash variety. It also may be employed with windows and doors made of aluminum, steel, vinyl, fiberglass composites and other suitable materials.

In other embodiments of the invention, a solar box structured to be inserted into a deck, floor or wall may provide an electrical outlet such as a USB. Some remotely positioned solar devices, which need not be a part of a building, may be employed on post caps or rail supports or a wall hung structure for providing a source of electrical energy.

Whereas particular embodiments of the invention have been described herein for purposed of illustration, it will be evident to those skilled in the art that numerous variations of the details may be made without departing from the invention as set forth in the appended claims.

1. A window screen comprising,
a screen frame having a pair of generally vertical parallel screen frame members,
a pair of generally horizontal frame members each secured to said generally vertically oriented frame members,
screen material secured to said frame,
a lower rail member secured to said first pair of vertically oriented frame members,
an upper rail member oriented generally parallel to said lower rail secured to said pair of vertical frame members in spaced relationship with respect to said lower rail member,
a solar collector secured to said first and second rail members,
a battery electrically connected to said solar collector to provide energy from said solar collector to charge said battery, and
said battery operatively associated with a power outlet.

2. The screen of claim 1 including,
said solar collector facing the exterior of said screen and said power outlet being accessable at the interior of said screen.

3. The screen of claim 2 including,
said lower rail member and said upper rail member each having an adjustable length.

4. The screen of claim 1 including,
said rails each having two components which are telescopically adjustable so as to permit them to be adjusted to the size of the screen frame.

5. The screen of claim 4 including,
an electrical wire extending from said solar collector through the interior of a said rail to said battery.

6. A window wall structure comprising a first framed panel overlying a second framed panel, and a third framed panel overlying a fourth framed panel,
said first and third panels being disposed in a generally side by side relationship with an interposed mullion,
at least one solar collector secured exteriorally of said mullions,
a storage battery and power outlet secured between said first and third framed panels,
a first wire electrically connecting said solar collector to said storage battery,
a second wire electrically connecting said storage battery to said power outlet, and
said power outlet being accessable at the interior of said window wall.

7. The window wall structure of claim 6 including,
said solar collector being oriented generally angularly, outwardly and downwardly.

8. The window wall structure of claim 6 including,
said solar collector having a plurality of individual solar collector elements.

9. The window wall structure of claim 6 including,
said first and third framed panels having glass panels as said panels.

10. A window assembly having an integral energy collecting and charging system comprising,
said window having two window panes, with one disposed at a higher elevation than the other when said window assembly is in a closed position,
said window having at least one moveable sash,
a window screen secured exteriorly of said window,
a solar collector secured exteriorly of said screen,
a storage battery,
said solar collector operatively associated with a storage battery for energizing the same, and
said storage battery operatively associated with a power outlet for energizing the same.

11. The window assembly of claim 10 comprising,
said screen being substantially co-extensive with both said window panes, and
said window being a double hung window.

12. The window assembly of claim 10 comprising,
a plurality of proximity chargers operatively associated with said solar collector and electrical wires connecting said proximity sensors with said power outlet.

13. The window assembly of claim 11 comprising,
said solar collector covering about 30 to 90 percent of the area of the lower of said two window panes.

14. The window assembly of claim 10 including,
said window being a single hung window.

15. The window assembly of claim 14 including,
said screen being rotatably secured exteriorly of a moveable sash in said single hung window.

16. The window assembly of claim 15 including,
said solar collector being secured to the exterior of said screen and extending downwardly and outwardly therefrom.

17. The window assembly of claim 14 including,
said screen being rotatable about a generally horizontal upper axis.

18. The window assembly of claim 10 including,
said solar collector energy being delivered to at least one of a battery charger and a charging pad for charging said battery which is structured to energize said power outlet.

19. A window having an integral energy collector and charging system comprising,
a window frame having an upper generally horizontally oriented frame member,
a lower generally horizontally oriented frame member,
a pair of generally vertically oriented frame members connected to opposite said horizontal frame members,
a solar collector projecting outwardly from the exterior of said upper frame member,
a storage battery operatively associated with said solar collector to be charged thereby,
said storage battery operatively associated with a power outlet which faces the window interior, and
said upper frame member having at least one ventilator opening.

20. The window of claim 19 including,
said solar collector disposed generally adjacent to said ventilator opening, and
said ventilator opening facing generally downwardly.

21. The window of claim 19 including,
said window having a fixed pane

22. A window having a fixed generally rectangular frame and a glass pane secured therein, and
said glass pane having a switchable glazing unit on the exterior thereof,
said switchable glazing unit being electrically connected to a charging base,
said charging base being electrically connected to a power outlet,
said switchable glazing unit being structured to become at least partially opaque responsive to application of electrical current thereto, and
said charging base and power outlet projecting toward the interior of said window.

23. The window of claim 22 including,
said electrochromatic layer covering about 100 percent the exposed portion of said glass panel.

24. A window assembly having an integral energy collector and charging system comprising,
said window having a movable first sash which is structured to move between a window open position and a window closed position,
a window sill underlying said first sash,
a solar collector secured to said window sill exteriorly of said window sash,
a storage battery and power outlet disposed interiorly of said window sash,
an electrical wire connecting said solar collector with said storage battery, and
said window sash having a compressible layer secured to the underside thereof, whereby said window sash provides sealing against weather and resistance to damage to said wire.

25. The window of claim 24 including,
said window being a wooden framed window and window sill being wooden.

26. A solar collecting structure comprising,
a housing having a generally vertical rear wall, a top wall, a lower wall and a front wall,
said front wall extending angularly, downwardly and outwardly with respect to said rear wall,
at least one solar collector secured to said front wall,
said solar collector operatively associated with a storage battery,
a weatherproof power outlet secured to said housing and being accessible from the exterior of said housing, and,
said storage battery operatively associate with a power outlet.

27. The solar collecting structure of claim 26 including,
said outer wall being angularly disposed with respect to said inner wall at an angle of about 20 to 40 degrees.

28. The solar collecting structure of claim 26 including,
said housing having a pair of solar collectors secured to said front wall.

29. The solar collecting structure of claim 26 including,
a mounting bracket secured to the rear wall of said housing for securing said housing to a structure.

30. The solar collecting structure of claim 29 including,
said storage outlet is a waterproof USB port.

31. The solar collecting unit of claim 26 including a light source secured to the exterior of said housing, and
said light source being electrically connected to said storage battery.

32. A solar collecting support member comprising,
generally vertically oriented parallel end walls and generally vertically oriented parallel side walls,
a pair of upwardly and inwardly sloped top walls,
a first said side wall having a solar collector secured thereto,
a second said side wall having a power outlet secured thereto,
a storage battery electrically connected to said solar collector for receiving energy therefrom, and
said storage battery electrically connected to said power outlet for delivering energy thereto.

33. The support member of claim 32 including,
said support member defining an upwardly open recess which is structured to receive an object which it supports.

34. The support foot of claim 33 including,
said recess being structured to receive a railing to support the same.

35. The support member of claim 34 including,
said support member structured to permit the solar collector to face the direction from which the sun exposure will occur, and
said power outlet is positioned to face the interior, whereby a railing may be firmly supported by said support member while facilitating energy collection and distribution.

36. A solar box assembly structured to be received within a floor or wall comprising, the box defining a chamber,
a box cover having at least one solar collector,
a weatherproof power outlet secured to said box,
a storage battery operatively associated with said solar collector,
said storage battery operatively associated with said power outlet, and
said box having an enlarged cover, whereby the box may be inserted into an opening in said floor or wall while resisting excess entry therethrough,

37. The solar box assembly of claim 36 including,
said box having a pair of solar collectors for energizing said storage battery.

38. The solar box assembly of claim 36 including,
said solar box made of a material selected from the group consisting of plastic, metal and composites.

39. The solar box assembly of claim 36 including,
said solar box having a translucent protective cover overlying said solar collector.

40. A solar post cap assembly having a hollow interior comprising,
a storage battery secured within said hollow interior,
a bottom wall,
a lateral wall out of which projects a weatherproof power outlet,
a top wall consisting of a plurality of top wall sections surrounding a solar collector,
a first electrical wire connecting said solar collector to a storage battery, and
a second electrical wire connecting said storage battery with said weatherproof power outlet.

41. The solar post cap assembly of claim 40 including,
said top wall including four trapezoidal shaped sections extending upwardly and inwardly toward said solar collector.

42. The solar post cap assembly of claim 41 including,
a support post secured to and supporting said post cap.

43. The solar post cap assembly of claim 40 including a light source secured to said cap assembly and being electrically connected to said storage battery.
